(19) United States
(12) Patent Application Publication
(10) Pub. No.: US 2026/0264800 A1
(43) Pub. Date: Sep. 10, 2026

(54) RECIPROCATING-PEDALING BICYCLE

(71) Applicant: Zhifeng YANG, Fengcheng City Yichun, Jiangxi (CN)

(72) Inventor: Zhifeng YANG, Fengcheng City Yichun, Jiangxi (CN)

(21) Appl. No.: 19/662,611

(22) Filed: Apr. 29, 2026

Related U.S. Application Data
(63) Continuation of application No. PCT/CN2024/098766, filed on Jun. 12, 2024.

(30) Foreign Application Priority Data
Oct. 29, 2023 (CN) 202311411258.6
May 12, 2024 (CN) 202410584572.2

(51) Int. Cl. B62M 1/28; B62M 9/04

(52) U.S. Cl. CPC B62M 1/28; B62M 9/04

(57) ABSTRACT

A walking bike, including: a frame and a pedal device. The frame includes a frame head pipe arranged at the front end or the rear end, a steering wheel support is hinged in the frame head pipe, and a steering wheel; a driving wheel and a driving wheel shaft are provided at the rear end or the front end of the frame; and one transmission mechanism or left and right transmission mechanisms are provided between the pedal device and the driving wheel; and each transmission mechanism includes a rope winding ring hinged to the driving wheel or the driving wheel shaft, a winding rope connected between the rope winding ring and the pedal device and winding around the rope winding ring, and a reset device connected to the rope winding ring and capable of driving the rope winding ring to rotate reversely.

### CROSS-REFERENCE TO RELATED APPLICATION

This application claims priority to Chinese Patent Application No. CN202311411258.6, entitled “A Reciprocating-Pedaling Bicycle with Multi-Gear Speed Change Function,” filed on Oct. 29, 2023, the entire contents of which are hereby incorporated by reference.

This application also claims priority to Chinese Patent Application No. CN202410584572.2, entitled “A Reciprocating-Pedaling Bicycle,” filed on May 12, 2024, the entire contents of which are hereby incorporated by reference.

### TECHNICAL FIELD

The present application relates to the field of personal transportation devices, and more particularly, to a Reciprocating-Pedaling Bicycle.

### BACKGROUND

Conventional bicycles adopt a full-rotational pedaling drive mode, which has significant limitations in terms of ergonomics and mechanical transmission efficiency.

First, the human leg achieves the highest force exertion efficiency when the knee joint is within the angular range close to extension; however, during the rotation of a conventional crank, this range corresponds exactly to the region where the effective moment arm approaches zero, resulting in failure to convert maximum pedaling force into effective driving force.

In addition, in rotational pedaling, the rider exerts force intensively only within a crank angle range of approximately 90° per full pedaling cycle. Furthermore, the effective moment arm still decreases significantly at the start and end stages of this range, causing the average effective moment arm to be substantially lower than the peak effective moment arm. The remaining period is basically in an idle state of ineffective driving, resulting in a waste of physical energy.

Due to the low proportion of the effective power stroke, the operability of enhancing the driving force by increasing the pedaling rate is very limited, and it is usually necessary to rely on a gear-shifting mechanism to adapt to different road conditions. However, conventional gear-shifting mechanisms have a complex structure, are prone to contamination, and introduce additional energy losses.

In addition, conventional hand brakes rely on manual operation; during normal riding, riders usually do not continuously hold the brake levers, resulting in difficulty in immediately applying braking force in sudden emergency situations and the problem of delayed braking response. Moreover, under certain circumstances, emergency braking may also cause vehicle instability (e.g., wheel skidding or rear-wheel lift). Furthermore, the disc brake system is prone to abnormal contact between the brake disc and the brake pads (commonly known as “disc rub”), generating unnecessary frictional resistance, wear, and continuous abnormal noise.

### SUMMARY

In view of the above, the present application aims to provide a reciprocating-pedaling bicycle that solves or at least significantly improves at least some of the defects identified in the above background art.

Specifically, the present application achieves its objectives through the following core improvements:

First, a high-efficiency drive mode adapted to the optimal force-exertion posture of the human body is provided.

The present application adopts a reciprocating pedaling drive mode, which adapts the motion stroke of the oscillating component to the optimal force-exertion angular range where the human knee joint is close to extension, optimizes force line transmission, and fully releases the leg pedaling force. By doing so, this mode eliminates power interruptions caused by periodic idling in conventional rotary pedaling, achieves more continuous effective driving, enables the basic pedaling rate to be reduced, further enhances the rider's operability in directly increasing vehicle speed and climbing ability by increasing the pedaling rate, and thus reduces reliance on complex gear-shifting mechanisms.

Second, a transmission geometric structure capable of achieving high-efficiency energy conversion is provided.

To improve the problem of attenuation of the effective moment arm at the two end regions of the power stroke in conventional cranks, the present application adopts small-angle reciprocating motion of the oscillating component combined with an optimized transmission design, which maintains the effective moment arm at a high level during the effective power stroke, thereby improving the conversion efficiency from leg force to driving torque and making the average effective moment arm closer to the maximum value.

Third, a foot brake device integrated into the drive mechanism is provided to achieve safe, stable, and efficient braking.

To overcome the defects of delayed response and poor stability in conventional braking systems, the present application integrates the braking function at the distal region of the oscillating crank. The foot brake device integrates the braking action as a natural extension of the pedaling motion, ensuring rapid response. During braking, the rider's weight is directly applied to the ground through the device via rolling contact; the strong normal force thereby generated combines with the relative sliding produced inside the device by such rolling contact to generate substantial sliding friction resistance, thereby achieving a strong and controllable braking effect. Since the rider's weight is directly applied to the ground via both feet and the left and right foot brake devices in the form of rolling contact, effectively allowing the rider to control the vehicle as if standing directly on the ground, this can effectively suppress instability such as lateral skidding of the vehicle body or rear-wheel lift during emergency braking. In addition, the device can eliminate disc rub, parasitic resistance, and abnormal noise that tend to occur in conventional disc brakes.

Fourth, reducing the load on the frame.

The present application optimizes the layout of the drive mechanism, so that the pedaling force directly acts on the drive wheel shaft, reducing the additional load borne by the frame and facilitating the lightweight design.

Fifth, a lightweight, durable, clean, and energy-efficient gear-shifting mechanism is provided.

The gear-shifting mechanism has a simple structure, convenient operation, contamination resistance, and maintenance-free performance, providing the vehicle with flexible multi-gear selection to meet the needs of different riding scenarios.

Sixth, multi-gear adaptability is achieved without an independent gear-shifting mechanism.

The present application further adopts a variety of structural designs, so that the vehicle can still have multiple driving gears to flexibly adapt to different slopes and road conditions even without configuring a gear-shifting mechanism:

Adaptive two-gear structure: two pedals, front and rear, are provided at the distal region of the oscillating crank, corresponding to the ball portion and the heel portion respectively. The front and rear pedals have different moment arms, and the rider can naturally switch the force application point according to road conditions to automatically adapt to different road conditions without any additional operation or mechanism;

Mechanical gear switching structure: a second winding chain attachment point and a protrusion structure are provided on the inner side of the oscillating crank; through the engagement and disengagement between the winding chain and the protrusion, convenient switching between high and low speed gears can be realized, further expanding the gear adaptation range.

To achieve the above objectives, the present application provides a reciprocating-pedaling bicycle, comprising a frame 1 and a pedal device. A head tube 1-1 is disposed at a front end of the frame 1. A front fork 2 is pivotally connected within the head tube 1-1, and a front wheel 3 is mounted at a lower end of the front fork 2. A drive wheel 9 and a drive wheel shaft 8 are disposed at a rear end of the frame 1. The bicycle is characterized in that:
one set or two left and right sets of transmission mechanisms are disposed between the pedal device and the drive wheel 9;
each set of the transmission mechanisms comprises:
a winding ring 13 pivotally connected to the drive wheel 9 or the drive wheel shaft 8, wherein a one-way transmission mechanism is provided between the winding ring 13 and the drive wheel 9 or the drive wheel shaft 8;
a winding chain 14 connected between the winding ring 13 and the pedal device, wherein a first end of the winding chain 14 is connected to the winding ring 13 and is windable thereon, and a second end of the winding chain 14 is connected to the pedal device; and
a return mechanism connected to the winding ring 13 and configured to drive the winding ring 13 to rotate in a reverse direction, thereby rewinding the winding chain 14 onto the winding ring 13.

Optionally, the drive wheel shaft 8 is pivotally connected to the frame 1 via a pair of first bearings 23, and the drive wheel 9 is fixedly connected to the drive wheel shaft 8. The winding ring 13 is pivotally connected to the drive wheel shaft 8 via two rows of steel balls 24 or a pair of bearings. The winding ring 13 is configured to transmit drive to the drive wheel shaft 8 in one direction only via a ratchet wheel 10 and a pawl 11. The ratchet wheel 10 is fixedly connected to the drive wheel shaft 8 or the drive wheel 9. A first pawl recess 13-1 is formed at one end of the winding ring 13 facing the ratchet wheel 10. The pawl 11 is mounted in the first pawl recess 13-1 via an annular spring 12. The first pawl recess 13-1 projects into the ratchet wheel 10, and the pawl 11 meshes with the ratchet wheel 10, such that the winding ring 13 is capable only of unidirectional rotation relative to the drive wheel shaft 8.

Optionally, the drive wheel shaft 8 is pivotally connected to the frame 1 via a pair of first bearings 23, and the drive wheel 9 is fixedly connected to the drive wheel shaft 8. The winding ring 13 is configured to transmit drive to the drive wheel shaft 8 in one direction only via a winding inner ring 97 and a pawl 11. The winding inner ring 97 is fixedly connected to the drive wheel shaft 8, and the winding ring 13 is pivotally connected to the winding inner ring 97 via two rows of small steel balls 98. A second pawl recess 97-3 is formed on the outer circumferential surface of the winding inner ring 97, and the pawl 11 is mounted in the second pawl recess 97-3 via an annular spring 12. Second ratchet teeth 13-10 are formed on an inner circumferential surface of the winding ring 13. The pawl 11 meshes with the second ratchet teeth 13-10, such that the winding ring 13 is capable only of unidirectional rotation relative to the winding inner ring 97.

Optionally, the drive wheel shaft 8 is fixedly connected to the frame 1, and the drive wheel 9 is pivotally connected on the drive wheel shaft 8 via a pair of first bearings 23. The winding ring 13 is configured to transmit drive to the drive wheel 9 in one direction only via a winding inner ring 97 and pawls 11. The winding inner ring 97 is fixedly connected to the drive wheel 9, and the winding ring 13 is pivotally connected to the winding inner ring 97 via two rows of small steel balls 98. A second pawl recess 97-3 is formed on the outer circumferential surface of the winding inner ring 97, and the pawls 11 are mounted therein via an annular spring 12. Second ratchet teeth 13-10 are formed on the inner circumferential surface of the winding ring 13. The pawls 11 mesh with the second ratchet teeth 13-10, such that the winding ring 13 is capable only of unidirectional rotation relative to the winding inner ring 97.

Optionally, the drive wheel shaft 8 is pivotally connected to the frame 1 via a pair of first bearings 23, and the drive wheel 9 is fixedly connected to the drive wheel shaft 8. The winding ring 13 constitutes an outer race of a one-way bearing 106, and the inner race thereof is fixedly connected to the drive wheel shaft 8.

Optionally, the drive wheel shaft 8 is fixedly connected to the frame 1, and the drive wheel 9 is pivotally connected on the drive wheel shaft 8 via a pair of first bearings 23. The winding ring 13 constitutes an outer race of a one-way bearing 106, and the inner race thereof is fixedly connected to the drive wheel 9.

Optionally, the return mechanism comprises a flexible wire 16 and a return spring 17. One end of the flexible wire 16 is connected to the winding ring 13, and the other end thereof is connected to the return spring 17. The other end of the return spring 17 is connected to the vehicle body. The winding ring 13 is provided with a flexible wire winding area 13-7 for winding the flexible wire 16 and a flexible wire attachment point 13-4 for connecting the flexible wire 16.

Optionally, the return mechanism consists of a return spring 17. One end of the return spring 17 is connected to the winding ring 13, and the other end thereof is connected to the vehicle body. The winding ring 13 is provided with a return spring winding area for winding the return spring 17 and a return spring attachment point for connecting the return spring 17.

Optionally, the outer circumferential surface of the winding ring 13 is provided with a winding chain winding area 13-9 for winding the winding chain 14 and a first winding chain attachment point 13-3 for connecting the winding chain 14.

Optionally, the winding ring 13 is provided with a spiral groove 13-2 for spirally winding the winding chain 14 and a first winding chain attachment point 13-3 for connecting the winding chain 14, wherein the first winding chain attachment point 13-3 is located at the starting end of the spiral groove 13-2.

Optionally, two sets of transmission mechanisms are provided, one on the left side and one on the right side. The frame 1 is provided with a bottom bracket shell 1-2 having an axis parallel to the transverse direction of the frame 1. Two independently rotatable left and right crank axles 5 are pivotally connected within the bottom bracket shell 1-2. The pedal device comprises left and right oscillating cranks 6, with pedals 7 disposed at distal regions thereof. The left and right oscillating cranks 6 are fixedly connected to outer ends of the corresponding crank axles 5, respectively. The second end of each winding chain 14 is connected to the distal region of the oscillating crank 6 on the same side.

Optionally, two sets of transmission mechanisms are provided, one on the left side and one on the right side. The frame 1 is provided with two bottom bracket shells 1-2 arranged side by side along the longitudinal direction of the frame 1. An axis of each bottom bracket shell 1-2 is parallel to the transverse direction of the frame 1. One crank axle 5 is pivotally connected in each bottom bracket shell 1-2. The two crank axles 5 extend toward the left side and the right side of the frame 1, respectively. The pedal device comprises left and right oscillating cranks 6, with pedals 7 disposed at distal regions thereof. The left oscillating crank 6 is fixedly connected to the leftward-extending end of the left crank axle 5, and the right oscillating crank 6 is fixedly connected to the rightward-extending end of the right crank axle 5. The second end of each winding chain 14 is connected to the distal region of the oscillating crank 6 on the same side.

Optionally, a single set of transmission mechanisms is provided, disposed on the right side of the drive wheel 9. The frame 1 is provided with a bottom bracket shell 1-2 having an axis parallel to the transverse direction of the frame 1. A crank axle 75 is pivotally connected within the bottom bracket shell 1-2. The pedal device comprises left and right oscillating cranks 6 respectively fixedly connected to two ends of the crank axle 75, and pedals 7 disposed at distal regions of the left and right oscillating cranks 6. The left and right oscillating cranks 6 are arranged in a mirror-image configuration such that, when their distal regions are simultaneously depressed, the driving torques generated on the left and right sides are in the same direction, thereby avoiding mutual cancellation. The second end of the winding chain 14 is connected to the distal region of the right oscillating crank 6.

Optionally, the left and right oscillating cranks 6 are connected into an integral unit via two middle cross tubes 6-11.

Optionally, a single set of transmission mechanism is provided, disposed on the right side of the drive wheel 9. The frame 1 is provided with a pedal base 1-19. The pedal device comprises an oscillating crank 6. One end of the oscillating crank 6 is provided with a cross tube 6-8. A pair of second bearings 83 are mounted at two ends of the cross tube 6-8, and the cross tube 6-8 is pivotally connected to the pedal base 1-19 via the pair of second bearings 83 and a crank axle 84. Pedal 7 is disposed at a distal region of the oscillating crank 6. The second end of the winding chain 14 is connected to the distal region of the oscillating crank 6.

Optionally, the frame 1 comprises left and right drive wheel mounting arms 1-8 at a rear end thereof. Rear ends of the drive wheel mounting arms 1-8 extend rearward beyond the drive wheel 9 and are connected via a tail rod 1-25. The pedal base 1-19 is disposed at a bottom of the tail rod 1-25. The cross tube 6-8 is disposed at a rear end of the oscillating crank 6. A front end of the oscillating crank 6 extends forward beyond the drive wheel 9, and the pedal 7 is disposed at the front end of the oscillating crank 6. The second end of the winding chain 14 is connected to a middle or front-middle portion along the length of the oscillating crank 6.

Optionally, two sets of transmission mechanisms are provided, one on the left side and one on the right side. The pedal device comprises a left reciprocating pedal 70 and a right reciprocating pedal 70. Each reciprocating pedal 70 is provided with a fourth winding chain attachment point 70-1. The second end of each winding chain 14 is connected to the fourth winding chain attachment point 70-1 on the same side.

Optionally, the frame 1 is provided with a pair of guide grooves 1-14, each located forward of a respective end of the drive wheel shaft 8. Each reciprocating pedal 70 is provided with a plurality of guide rollers 73. The guide rollers 73 extend into the guide grooves 1-14. Side walls of the guide grooves 1-14 guide and constrain the guide rollers 73, thereby guiding the reciprocating pedals 70 and the guide rollers 73 to move up and down along a trajectory defined by the guide grooves 1-14.

Optionally, the distal region of the oscillating crank 6 faces the rear of the frame 1. When the distal region is returned to a return high position under a pulling force transmitted from the return mechanism via the winding ring 13 and the winding chain 14, a terminal portion of the distal end is positioned adjacent to the winding ring 13 or extends rearward past an axis of the drive wheel shaft 8. With this configuration, a pedaling force acts directly on the drive wheel 9 via the winding chain 14 and the winding ring 13, thereby substantially reducing a load on the frame 1, lowering a required rigidity of the frame 1, and facilitating a reduction in an overall weight of the bicycle.

Optionally, two pedals 7 are arranged at the distal end of the oscillating crank 6 along its length direction, corresponding to the forefoot and the heel portion respectively.

During normal riding, the rider may mainly step on the rear pedal 7 corresponding to a longer moment arm with the heel during the first two-thirds of the pedaling stroke, so as to obtain a larger moment arm; as the knee joint approaches extension, the ankle joint continues to apply force to complete the last one-third of the stroke with the forefoot. This significantly reduces the foot lift height required for each pedaling cycle and helps improve the pedaling rate.

In addition, this structure supports a long moment arm pedaling mode suitable for uphill riding: the rider stops pedaling when the knee joint is about to extend, then lifts the leg to enter the next stroke. During the entire pedaling process, the rider always steps on the rear pedal 7 with the heel, and can output greater driving force by utilizing its longer moment arm.

Therefore, the rider can actively select the force application mode to flexibly adapt to riding requirements under different road conditions.

Optionally, the pedal 7 corresponding to the ball portion is pivotally connected to the oscillating crank 6, and the pedal 7 corresponding to the heel portion is fixedly connected to the oscillating crank 6. A rear end of the oscillating crank 6 is bent upward at an appropriate angle so that the distal region of the oscillating crank 6 can be depressed to a lower position.

Optionally, a second winding chain attachment point 6-3 is provided on an inner side surface of the oscillating crank 6, at a middle, front-middle, or rear-middle portion along the length direction thereof. A second end of the winding chain 14 is connected to the second winding chain attachment point 6-3. A protrusion 6-14 is disposed on a side of the second winding chain attachment point 6-3 facing a distal region of the oscillating crank 6, the protrusion 6-14 being laterally aligned with a path of the winding chain 14. A top surface of the protrusion 6-14 is formed as an inclined guide surface configured to guide the winding chain 14 to slide therealong and become caught beneath the protrusion 6-14, thereby establishing a first connection state.

When the distal region of the oscillating crank 6 swings upward beyond a predetermined height, the winding chain 14 slides along the inclined top surface and settles beneath the protrusion 6-14. Upon a subsequent pedaling stroke, the winding chain 14 becomes caught under the protrusion 6-14, placing the winding chain 14 in the first connection state corresponding to a high-speed gear of the reciprocating-pedaling bicycle. In the first connection state, the winding chain 14 transmits a pulling force to the oscillating crank 6 via the protrusion 6-14.

In the high-speed gear, when the distal region of the oscillating crank 6 is at a relatively low position, the rider can use the inner side of the foot to nudge the winding chain 14 inward. This action causes the winding chain 14 caught beneath the protrusion 6-14 to slide inwardly from under the protrusion 6-14, thereby disengaging from the protrusion 6-14. The winding chain 14 then connects directly to the second winding chain attachment point 6-3, entering a second connection state corresponding to a low-speed gear of the bicycle. In the second connection state, the winding chain 14 is disengaged from the protrusion 6-14 and transmits the pulling force directly to the oscillating crank 6 through the second winding chain attachment point 6-3.

Accordingly, to shift from the low-speed gear to the high-speed gear, the rider need only, when the distal region of the oscillating crank 6 is at the pedaling low position, quickly move the foot laterally outward away from the pedal 7. The distal region of the oscillating crank 6 then automatically rebounds upward under the spring force of the return mechanism, exceeding a normal return height. This causes the winding chain 14 to slide along the inclined top surface of the protrusion 6-14 and settle therebeneath, thereby automatically completing the shift from the second connection state (low-speed gear) to the first connection state (high-speed gear).

Optionally, a foot brake device is provided at the distal end of the oscillating crank 6. The foot brake device comprises: a friction inner ring 103 fixedly connected to the distal end of the oscillating crank 6; a friction intermediate ring 104 mounted over the friction inner ring 103, wherein the friction intermediate ring 104 is rotatable relative to the friction inner ring 103 but axially restrained relative thereto; and a rubber outer ring 105 fixedly attached to an outer circumferential surface of the friction intermediate ring 104.

Optionally, the friction inner ring 103 is fixedly connected to an outer side of the distal end of the oscillating crank 6. When the distal region of the oscillating crank 6 is depressed below a normal pedaling low position, the rubber outer ring 105 contacts the ground and rolls therealong, generating sliding friction between the friction intermediate ring 104 and the friction inner ring 103, thereby achieving braking.

Optionally, the friction inner ring 103 is fixedly connected to an inner side of the distal end of the oscillating crank 6, and the rubber outer ring 105 is laterally aligned with a rim 9-2 of the drive wheel 9. When the distal region of the oscillating crank 6 is depressed below the normal pedaling low position, the rubber outer ring 105 presses against the rim 9-2 of the drive wheel 9. When the rubber outer ring 105 presses against the rotating rim 9-2 of the drive wheel 9, the rubber outer ring 105 rolls along the rim 9-2, generating sliding friction between the friction intermediate ring 104 and the friction inner ring 103, thereby achieving braking.

Optionally, a seat 29 is provided above a rear end of the frame 1, with a load-bearing center thereof located directly above or rearward of the drive wheel shaft 8. This arrangement contributes to a more compact overall vehicle structure.

Optionally, a plurality of pairs of pawls 11 are mounted on an outer circumferential surface of the winding inner ring 97. The pairs of pawls 11 are circumferentially staggered relative to second ratchet teeth 13-10. Specifically, when distal ends of one pair of pawls 11 abut a front face 13-10-1 of the second ratchet teeth 13-10, distal ends of remaining pairs press against different positions on an inclined face 13-10-2 thereof. The second ratchet teeth 13-10, formed on an inner circumferential surface of the winding ring 13, have a tooth pitch of approximately 3 millimeters. Consequently, when a distal region of the oscillating crank 6 transitions from an automatic upward rebound to a downward pedaling stroke, the winding ring 13 drives the winding inner ring 97 via one of the pairs of pawls within a forward backlash of less than one-third of the tooth pitch—i.e., less than 1 millimeter—thereby significantly reducing forward backlash of the winding ring 13.

Optionally, the oscillating crank 6 is provided with a winding chain connecting arm 6-9, and the second end of the winding chain 14 is connected to a distal region of the winding chain connecting arm 6-9.

Optionally, the distal region of the oscillating crank 6 faces the front of the frame 1. When the oscillating crank 6 is in a horizontal position with the distal region oriented forward, the distal region of the winding chain connecting arm 6-9 points upward. As the distal region of the oscillating crank 6 moves downward, the distal region of the winding chain connecting arm 6-9 pulls the second end of the winding chain 14 forward, thereby rotating the winding ring 13.

Optionally, the distal region of the oscillating crank 6 faces the rear of the frame 1. When the oscillating crank 6 is in a horizontal position with the distal region oriented rearward, the distal region of the winding chain connecting arm 6-9 points downward. As the distal region of the oscillating crank 6 moves downward, the distal region of the winding chain connecting arm 6-9 pulls the second end of the winding chain 14 forward, thereby rotating the winding ring 13.

Optionally, the winding chain 14 is composed of a chain portion 14-1 and a rigid steel wire portion 14-2 connected together. A portion of the winding chain 14 that is configured to be wound onto the winding ring 13 is the chain portion 14-1, and a portion that is not configured to be wound onto the winding ring 13 is the rigid steel wire portion 14-2. A first end of the chain portion 14-1 is connected to the winding ring 13, a second end of the chain portion 14-1 is connected to a first end of the rigid steel wire portion 14-2, and a second end of the rigid steel wire portion 14-2 is connected to the distal region of the winding chain connecting arm 6-9.

Optionally, a gear-shifting mechanism is provided at the distal region of the oscillating crank 6. The gear-shifting mechanism includes: a slide rail 6-12 provided on the oscillating crank 6; a sliding sleeve 19 slidably mounted on the slide rail 6-12 and movable therealong; a locking lever 20 for locking the sliding sleeve 19 at different gear positions on the slide rail 6-12; and a torsion return spring 21 biasing the locking lever 20 toward a locked position. The sliding sleeve 19 is provided with a third winding chain attachment point 19-1, to which the second end of the winding chain 14 is connected.

Optionally, the locking lever 20 is pivotally connected to the oscillating crank 6. A distal region of the locking lever 20 is provided with an actuation tab 20-2 and at least one limit stop 20-1. When two or more limit stops 20-1 are provided, a spacing between adjacent limit stops 20-1 corresponds to a length of the sliding sleeve 19.

The torsion return spring 21 biases the locking lever 20 such that distal ends of the limit stops 20-1 press against the slide rail 6-12, thereby preventing the sliding sleeve 19 from moving along the slide rail 6-12.

When the actuation tab 20-2 is operated, the locking lever 20 rotates against the bias of the torsion return spring 21, such that the distal ends of the limit stops 20-1 disengage from the slide rail 6-12, thereby allowing the sliding sleeve 19 to move along the slide rail 6-12 to another gear position under a pulling force from the winding chain 14.

Thus, when the actuation tab 20-2 is operated against the torsion return spring 21 while the distal region of the oscillating crank 6 is at a high position or a low position, the distal end of the locking lever 20 rotates against the torsion return spring 21, the distal ends of the limit stops 20-1 disengage from the slide rail 6-12, and the sliding sleeve 19 slides along the slide rail 6-12 under the pulling force of the winding chain 14. When the distal region of the oscillating crank 6 is at the high position, the sliding sleeve 19 slides in a direction away from the crank axle; when the distal region of the oscillating crank 6 is at the low position, the sliding sleeve 19 slides in a direction toward the crank axle, thereby automatically completing gear shifting.

Optionally, a plurality of locking recesses 6-13 are provided on the oscillating crank 6 at predetermined intervals. The locking lever 20 is pivotally connected to the sliding sleeve 19. A distal region of the locking lever 20 is provided with an actuation tab 20-2, and the locking lever 20 is provided with a latch 20-3. The torsion return spring 21 is connected between the sliding sleeve 19 and the locking lever 20. When the latch 20-3 moves with the sliding sleeve 19 into alignment with any of the locking recesses 6-13, the torsion return spring 21 biases the locking lever 20 such that the latch 20-3 engages with said locking recess 6-13, thereby locking the sliding sleeve 19 in position.

When the actuation tab 20-2 is operated, the locking lever 20 rotates against the bias of the torsion return spring 21 such that the latch 20-3 disengages from the locking recess 6-13, thereby allowing the sliding sleeve 19 to move along the slide rail 6-12 to another gear position.

Optionally, a gear-shifting mechanism is provided at a distal region of the winding chain connecting arm 6-9. The gear-shifting mechanism includes a slide rail 6-12 provided on the winding chain connecting arm 6-9, a sliding sleeve 19 slidably mounted on the slide rail 6-12 and movable therealong, a locking lever 20 for locking the sliding sleeve 19 at different gear positions on the slide rail 6-12, and a torsion return spring 21 connected between the locking lever 20 and the winding chain connecting arm 6-9 and biasing the locking lever 20 toward a locked position.

The sliding sleeve 19 is provided with a third winding chain attachment point 19-1, and the second end of the winding chain 14 is connected to the third winding chain attachment point 19-1.

The locking lever 20 is pivotally connected to the winding chain connecting arm 6-9 via a lever shaft 22. A distal region of the locking lever 20 is provided with an actuation tab 20-2 and at least one limit stop 20-1. When two or more limit stops 20-1 are provided, a spacing between adjacent limit stops 20-1 corresponds to a length of the sliding sleeve 19.

The torsion return spring 21 biases the locking lever 20 such that distal ends of the limit stops 20-1 press against the slide rail 6-12, thereby preventing the sliding sleeve 19 from moving along the slide rail 6-12.

When the actuation tab 20-2 is operated, the locking lever 20 rotates against the bias of the torsion return spring 21 such that the distal ends of the limit stops 20-1 disengage from the slide rail 6-12, thereby allowing the sliding sleeve 19 to move along the slide rail 6-12 to another gear position under a pulling force from the winding chain 14.

Thus, when the actuation tab 20-2 is operated against the torsion return spring 21 while the distal region of the oscillating crank 6 is at a high position or a low position, the distal end of the locking lever 20 rotates against the torsion return spring 21, the distal ends of the limit stops 20-1 disengage from the slide rail 6-12, and the sliding sleeve 19 slides along the slide rail 6-12 under the pulling force of the winding chain 14. When the distal region of the oscillating crank 6 is at the high position, the sliding sleeve 19 slides in a direction away from the crank axle; when the distal region of the oscillating crank 6 is at the low position, the sliding sleeve 19 slides in a direction toward the crank axle, thereby automatically completing gear shifting.

### Beneficial Effects

The Reciprocating-Pedaling Bicycle provided by the present application addresses the limitations of conventional bicycles in terms of driving efficiency, braking safety, mechanical architecture, and transmission complexity. Through synergistic innovations in driving and braking modes, force transmission paths, and transmission systems—combined with specific component designs and quantified parameters—the invention achieves significant improvement in overall vehicle performance. The core beneficial effects are as follows:

### I. Significantly Improved Driving Efficiency and Ergonomic Compatibility

### 1. Optimized Force-Application Posture and Reduced Joint Load

The reciprocating pedaling drive mode adapts the motion range of the oscillating crank to the optimal force-exertion angular range where the human knee joint is close to extension, which achieves efficient force line transmission and enables full release of leg strength. Meanwhile, it reduces ineffective motion and effectively decreases knee joint load and muscle group fatigue.

### 2. Doubled Effective Stroke and Enhanced Pedaling Rate Capability

The reciprocating drive of the present application achieves a doubling of the effective power stroke (approximately twice that of a conventional bicycle), providing the rider with greater room for adjusting the pedaling rate to directly enhance vehicle speed and climbing ability by increasing the pedaling rate, thereby significantly reducing dependence on complex gear-shifting mechanisms.

### 3. Optimized Transmission Geometry and High Energy Conversion Efficiency

In a preferred embodiment, an oscillating crank with a length of approximately 35 centimeters performs a small-angle reciprocating motion of about 42°, which maintains the effective moment arm at a high level close to the maximum value throughout the stroke. The average effective moment arm reaches approximately 97% of the maximum value, significantly higher than the approximately 90% typical of conventional bicycles, thereby significantly improving the conversion efficiency from pedaling force to driving torque.

### 4. High Pedaling Rate Potential and Excellent Dynamic Response

The reduction of ineffective stroke and ergonomic optimization, combined with the front and rear dual-pedal structure at the distal region of the oscillating crank, effectively reduces the foot-lift height, laying a structural foundation for further increasing the pedaling rate (the pedaling rate can be increased by approximately 80% compared with conventional bicycles), thereby endowing the vehicle with more agile dynamic response to quickly adapt to different road conditions and speed changes.

II. Significantly Improved Braking Safety, Stability, and Reliability

### 1. Rapid Braking Response and Natural Operation

The foot brake device is integrated at the distal region of the oscillating crank, integrating the braking action as a natural extension of the pedaling motion. In an emergency, the pedaling motion can be immediately extended into a braking motion, with rapid response to meet the demand for emergency braking.

### 2. Strong Braking Effect and Stable Vehicle Body

During braking, the rider's weight is directly applied to the ground through the device via rolling contact. The strong normal force generated thereby combines with the relative sliding produced inside the device due to such rolling contact to form high sliding friction resistance, so as to achieve a strong and controllable braking effect. Since the rider's weight is directly applied to the ground via both feet and the left and right foot brake devices in the form of rolling contact, which is equivalent to controlling the vehicle while standing directly on the ground, this can effectively suppress instability such as lateral skidding of the vehicle body or rear-wheel lift during emergency braking, and ensure a stable vehicle body during braking.

### 3. Avoiding Conventional Braking Defects

The foot brake structure can effectively avoid disc rub, parasitic resistance and abnormal noise commonly found in conventional disc brakes.

### III. Efficient Vehicle Mechanical Architecture Supporting Lightweight and Compact Design

### 1. Direct Force Path and Reduced Frame Load

The layout of the drive mechanism is optimized, enabling pedaling force to act directly on the drive wheel shaft via the winding chain and winding ring. This greatly reduces the additional load borne by the frame, thereby lowering the rigidity requirement for the frame and facilitating lightweight design.

### 2. Compact Vehicle Layout and Convenient Handling

The saddle is positioned directly above or rearward of the drive wheel shaft. While ensuring stable center of gravity and efficient force application, this arrangement reasonably shortens the overall vehicle length by shifting the rider's center of gravity rearward, thereby improving handling and storage convenience.

### IV. Simple and Reliable Transmission System

The invention employs a compact winding chain transmission mechanism with a short force transmission path, which effectively suppresses lateral oscillation of the winding chain and reduces energy loss. Compared with conventional long transmission chains, this mechanism significantly reduces the risks of chain derailment, chain skipping, and wear, thereby enhancing transmission reliability and service life.

### V. Multi-Gear Adaptation Capability and Reduced Dependence on Gear Shifting

### 1. Adaptive Dual-Gear Functionality

The distal region of the oscillating crank is equipped with front and rear pedals having different moment arms, corresponding to the ball portion and the heel portion respectively, allowing natural switching between different moment arms and improving road adaptability.

### 2. Mechanically Switchable Gear Expansion

High and low speed gears can be conveniently switched through the second winding chain attachment point and the protrusion structure. Combined with the moment arm difference between the front and rear pedals, this provides multiple transmission combinations, which, coupled with the significantly increased pedaling rate, enables the system to adapt to diverse road conditions without a complex gear-shifting mechanism.

### 3. Optional Lightweight Gear-Shifting Mechanism

An optional purely mechanical gear-shifting mechanism comprising a slide rail, a sliding sleeve and a locking lever is easy to operate, contamination-resistant, and maintenance-free, providing users with more gear options.

### VI. Optional Linear Reciprocating Drive for High-Efficiency Transmission

In another preferred embodiment, a linear reciprocating drive structure is employed: the reciprocating pedals move vertically along guide slots in the frame via guide rollers, and the winding chain directly connects the pedals to the drive mechanism. This configuration eliminates the periodic attenuation of the effective moment arm inherent in rotational pedaling. Transmission losses are extremely low, yielding an energy conversion efficiency exceeding 98%, while retaining the key advantage that pedaling force is transmitted directly to the drive wheel shaft.

The foregoing description is merely an overview of the technical solution of the present application. To enable a clearer understanding of the technical means of the present application for implementation according to the contents of the specification, and to make the above-mentioned and other objectives, features, and advantages of the present application more apparent and understandable, specific embodiments of the present application are set forth below.

### BRIEF DESCRIPTION OF THE DRAWINGS

Upon reading the following detailed description of the preferred embodiments, various other advantages and benefits will become readily apparent to those of ordinary skill in the art. The drawings are intended solely to illustrate the preferred embodiments and should not be construed as limiting the present application. In the drawings:

FIG. 1 is a schematic diagram showing the overall structure of Embodiment 1.

FIG. 2 is a right-side view of FIG. 1.

FIG. 3 is a top view of FIG. 1.

FIG. 4 is a rear view of FIG. 1.

FIG. 5 is a partially enlarged view of FIG. 1 with some structures omitted.

FIG. 6 is a schematic diagram of the structure shown in FIG. 5 with some parts omitted.

FIGS. 7 and 8 are partially enlarged views of FIG. 6 with some structures omitted, respectively.

FIG. 9 is a partially enlarged view of FIG. 8 with some structures omitted.

FIG. 10 is an exploded view of part of the structure shown in FIG. 9.

FIG. 11 is a schematic diagram of the frame in FIG. 1.

FIG. 12 is a schematic diagram of the right-side winding ring and the two rows of steel balls at its ends in FIG. 1.

FIG. 13 is a top view of FIG. 12.

FIG. 14 is a rear view of FIG. 12.

FIG. 15 is a right-side view of FIG. 12.

FIGS. 16 and 17 are schematic diagrams of the right-side ratchet wheel in FIG. 1.

FIG. 18 is a schematic diagram showing the overall structure of Embodiment 2.

FIG. 19 is a schematic diagram of the winding chain in FIG. 18.

FIG. 20 is a right-side view of FIG. 18.

FIG. 21 is a rear view of FIG. 18.

FIG. 22 is a top view of FIG. 18 with some structures omitted.

FIG. 23 is a schematic diagram of the winding ring in FIG. 18.

FIG. 24 is a top view of FIG. 23.

FIG. 25 is a schematic diagram of the right-side oscillating crank in FIG. 18.

FIG. 26 is a top view of FIG. 25.

FIG. 27 is a schematic diagram showing the overall structure of Embodiment 3.

FIG. 28 is a right-side view of FIG. 27.

FIG. 29 is a top view of FIG. 27 with some structures omitted.

FIG. 30 is a partially enlarged view of FIG. 27 with some structures omitted.

FIG. 31 is a partially enlarged view of FIG. 30 as seen from another perspective.

FIG. 32 is a partially enlarged view of FIG. 31 with some structures omitted.

FIG. 33 is a schematic diagram of the locking lever in FIG. 32.

FIG. 34 is a schematic diagram of the sliding sleeve in FIG. 32.

FIG. 35 is a schematic diagram of the oscillating crank and the lever shaft in FIG. 30.

FIG. 36 is a schematic diagram showing the overall structure of Embodiment 4.

FIG. 37 is a right-side view of FIG. 36.

FIG. 38 is a top view of FIG. 36 with some structures omitted.

FIG. 39 is a schematic diagram showing the overall structure of Embodiment 4 as seen from another perspective.

FIG. 40 is a partially enlarged view of FIG. 39 with some structures omitted.

FIG. 41 is a schematic diagram of the right-side oscillating crank in FIG. 36.

FIG. 42 is a right-side view of FIG. 41.

FIG. 43 is a schematic diagram of the winding ring in FIG. 36.

FIG. 44 is a bottom view of FIG. 43.

FIG. 45 is a schematic diagram of the frame in FIG. 36.

FIG. 46 is a schematic diagram showing the overall structure of Embodiment 5.

FIG. 47 is a top view of FIG. 46 with some structures omitted.

FIG. 48 is a schematic diagram showing the overall structure of Embodiment 6.

FIG. 49 is a top view of FIG. 48 with some structures omitted.

FIG. 50 is a right-side view of FIG. 48.

FIG. 51 is a partially enlarged view of FIG. 48 with some structures omitted.

FIG. 52 is a partially enlarged view of FIG. 51 with some structures omitted.

FIG. 53 is a schematic diagram of the reciprocating pedal and the guide rollers in FIG. 52.

FIG. 54 is a top view of FIG. 53.

FIGS. 55 and 56 are schematic diagrams of the right-side winding ring in FIG. 52.

FIG. 57 is a rear view of FIG. 56.

FIG. 58 is a schematic diagram of the frame in FIG. 48.

FIGS. 59 and 60 are schematic diagrams showing the overall structure of Embodiment 7.

FIG. 61 is a right-side view of FIG. 59.

FIG. 62 is a partially enlarged view of FIG. 59 with some structures omitted.

FIG. 63 is a partially enlarged view of FIG. 62 with some structures omitted.

FIG. 64 is an exploded view of FIG. 62 with some structures omitted.

FIG. 65 is a schematic diagram of the brake arm and the brake pad in FIG. 59.

FIG. 66 is a schematic diagram of the right-side oscillating crank in FIG. 59.

FIG. 67 is a schematic diagram showing the overall structure of Embodiment 8.

FIG. 68 is a schematic diagram of the right-side oscillating crank in FIG. 67.

FIG. 69 is a partially enlarged view of FIG. 67 with some structures omitted.

FIGS. 70 and 71 are partially enlarged views of FIG. 69 with some structures omitted, respectively.

FIG. 72 is an exploded view of FIG. 70.

FIG. 73 is a right-side view of FIG. 67.

FIG. 74 is a top view of FIG. 67 with some structures omitted.

FIG. 75 is a rear view of FIG. 67.

FIG. 76 is a schematic diagram of the winding inner ring in FIG. 67.

FIG. 77 is a schematic diagram of the winding ring in FIG. 67.

FIG. 78 is a rear view of FIG. 77.

FIG. 79 is a schematic diagram of the sliding sleeve in FIG. 71 with the winding chain joint and the joint axle omitted.

FIG. 80 is a schematic diagram showing the overall structure of Embodiment 9.

FIG. 81 is a right-side view of FIG. 80.

FIG. 82 is a top view of FIG. 80 with some structures omitted. FIG. 83 is a partially enlarged view of FIG. 80 with some structures omitted.

FIG. 84 is a partially enlarged view of FIG. 83 with some structures omitted.

FIG. 85 is an exploded view of FIG. 84 with some structures omitted.

FIG. 86 is a partially enlarged view of FIG. 83 with some structures omitted.

FIG. 87 is a right-side view of FIG. 86.

FIG. 88 is a schematic diagram of the winding ring in FIG. 86.

FIG. 89 is a schematic diagram of the winding inner ring in FIG. 86.

FIG. 90 is a schematic diagram showing the overall structure of Embodiment 10.

FIG. 91 is a right-side view of FIG. 90.

FIG. 92 is a left-side view of FIG. 90 with the winding chain omitted and the distal region of the oscillating crank at the pedaling low position.

FIG. 93 is a partially enlarged view of FIG. 90 with some structures omitted.

FIG. 94 is an exploded view of FIG. 93 with some structures omitted.

FIG. 95 is a schematic diagram of the oscillating crank in FIG. 94.

FIG. 96 is a schematic diagram showing the overall structure of Embodiment 11.

FIG. 97 is a right-side view of FIG. 96.

FIG. 98 is a top view of FIG. 96 with some structures omitted.

FIG. 99 is a partially enlarged view of FIG. 96 with some structures omitted.

FIG. 100 is a partially enlarged view of FIG. 99 with some structures omitted.

FIG. 101 is a schematic diagram of the one-way bearing in FIG. 100.

### Explanation of Reference Numerals

1. frame, 1-1. head tube, 1-2. bottom bracket shell, 1-3. pulley shaft, 1-4. seat tube, 1-7. frame longitudinal beam, 1-8. drive wheel mounting arm, 1-14. guide groove, 1-18. limit plate, 1-19. pedal base, 1-24. cross shaft tube, 1-25. tail rod, 2. front fork, 3. front wheel, 4. handlebar, 5. crank axle, 6. oscillating crank, 6-3. second winding chain attachment point, 6-8. cross tube, 6-9. winding chain connecting arm, 6-10. fifth winding chain attachment point, 6-11. middle cross tube, 6-12. slide rail, 6-13. locking recess, 6-14. protrusion, 6-15. mounting ring, 6-16. stop block, 7. pedal, 8. drive wheel shaft, 9. drive wheel, 9-2. drive wheel rim, 10. ratchet wheel, 10-1. ratchet teeth, 10-2. ratchet sidewall, 10-3. sealing lip, 11. pawl, 12. annular spring, 13. winding ring, 13-1. first pawl recess, 13-2. spiral groove, 13-3. first winding chain attachment point, 13-4. flexible wire attachment point, 13-5. ball cup, 13-6. sealing wall, 13-7. flexible wire winding area, 13-8. winding disk, 13-9. winding chain winding area, 13-10. second ratchet teeth, 13-10-1. second ratchet teeth front face, 13-10-2. second ratchet teeth inclined face, 13-11. flexible wire retaining lip, 14. winding chain, 14-1. chain portion, 14-2. rigid steel wire portion, 15. fixed pulley, 16. flexible wire, 17. return spring, 19. sliding sleeve, 19-1. third winding chain attachment point, 19-3. winding chain joint, 19-4. joint axle, 19-5. anti-slip stud, 20. locking lever, 20-1. limit stop, 20-2. actuation tab, 20-3. latch, 21. torsion return spring, 22. lever shaft, 23. first bearing, 24. steel balls, 25. ball retainer, 26. outer cup, 27. bidirectional inner cup, 28. seat post, 29. seat, 30. folding buckle, 64. brake return spring, 70. reciprocating pedal, 70-1. fourth winding chain attachment point, 71. fender, 73. guide roller, 75. crank axle, 83. second bearing, 84. crank axle, 97. winding inner ring, 97-1. inner ring body, 97-2. inner ring cover, 97-3. second pawl recess, 98. small steel balls, 99. third bearing, 100. brake cross shaft, 101. brake arm, 101-1. brake pad base, 101-2. push tube, 101-3. cross stopper, 102. brake pad, 103. friction inner ring, 104. friction intermediate ring, 104-1. retaining lip, 105. rubber outer ring, 106. one-way bearing.

### DETAILED DESCRIPTION OF THE EMBODIMENTS

The technical solutions in the embodiments of the present application will be clearly and completely described below with reference to the accompanying drawings. It is evident that the described embodiments are only part of the embodiments of the present application, not all of them. All other embodiments obtained by a person of ordinary skill in the art based on the embodiments of the present application without creative effort shall fall within the scope of protection of the present application.

Unless otherwise defined, all technical and scientific terms used herein have the same meanings as commonly understood by one skilled in the technical field of this application. The terms used herein are for the purpose of describing specific embodiments only and are not intended to limit the application. In the description and claims of this application and the brief description of the drawings above, the terms “comprise,” “have,” and any variations thereof are intended to cover non-exclusive inclusion.

In the description of the embodiments of the present application, unless expressly stated or limited otherwise, technical terms such as “mount,” “connect,” “join,” “fix,” and the like shall be interpreted broadly. For example, a connection may be fixed or detachable, or may form an integral unit; it may be mechanical or electrical; it may be direct or indirect through an intermediary; it may indicate internal communication between two elements or an interaction relationship between them. A person of ordinary skill in the art can understand the specific meanings of the aforementioned terms in the embodiments of the present application according to specific circumstances.

### Embodiment 1

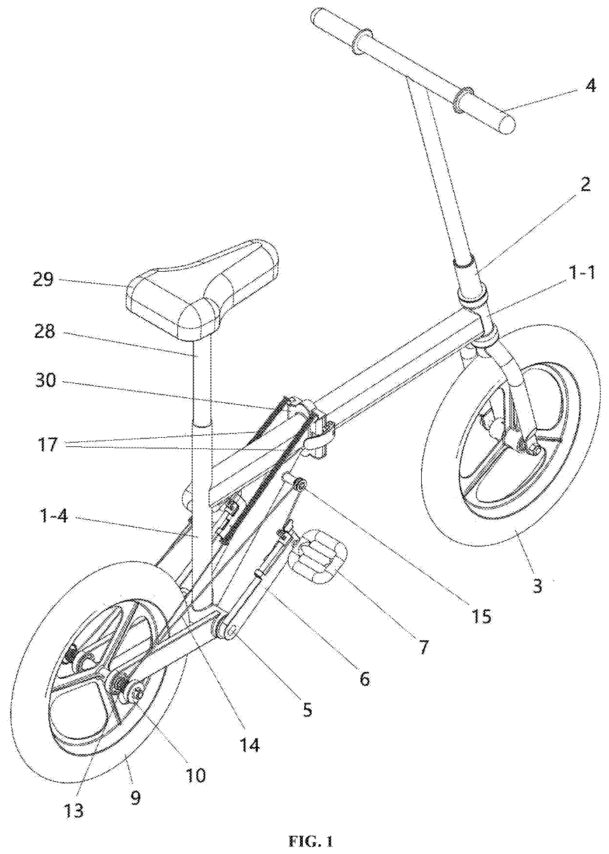

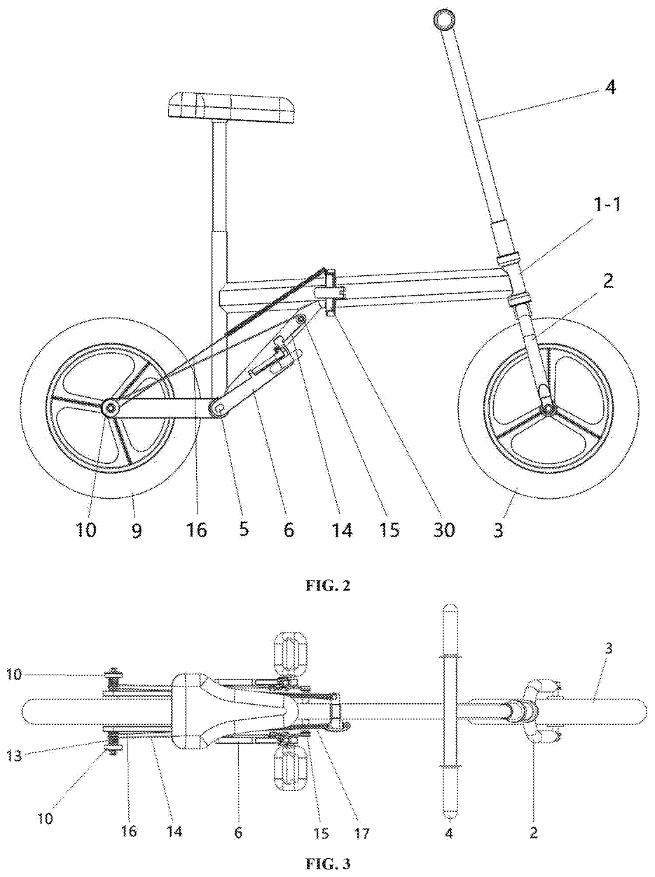

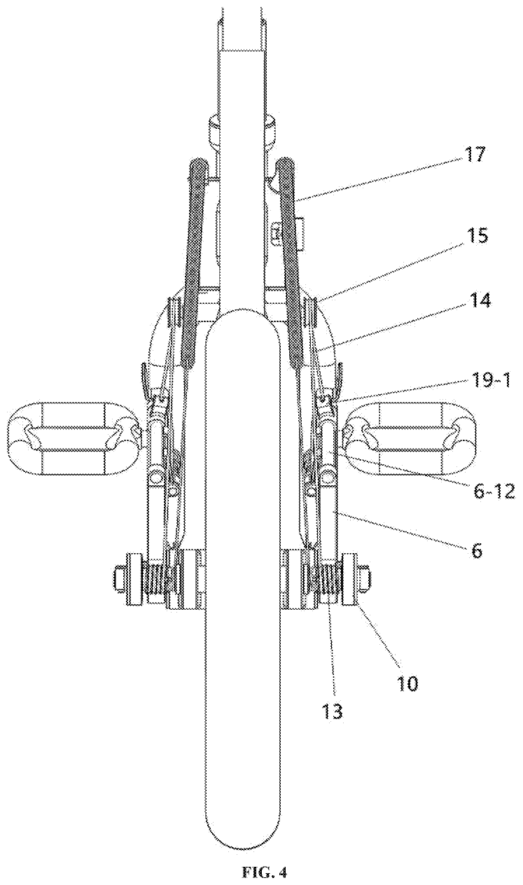

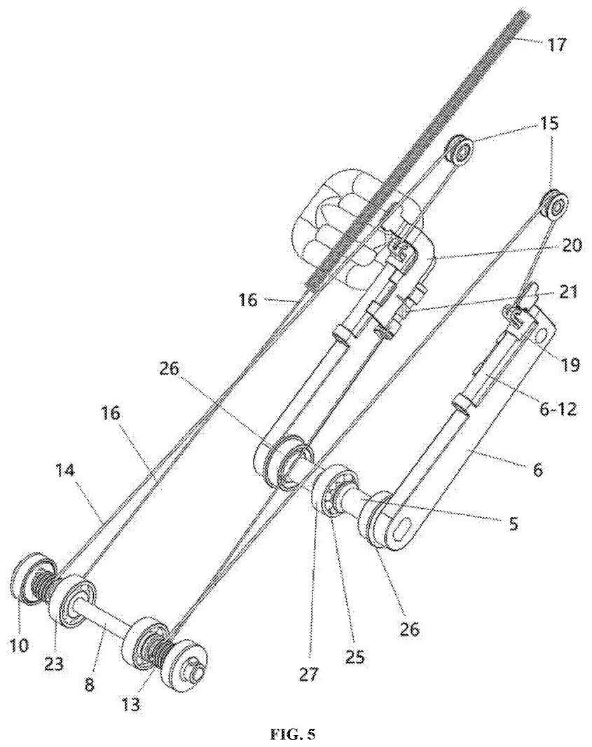

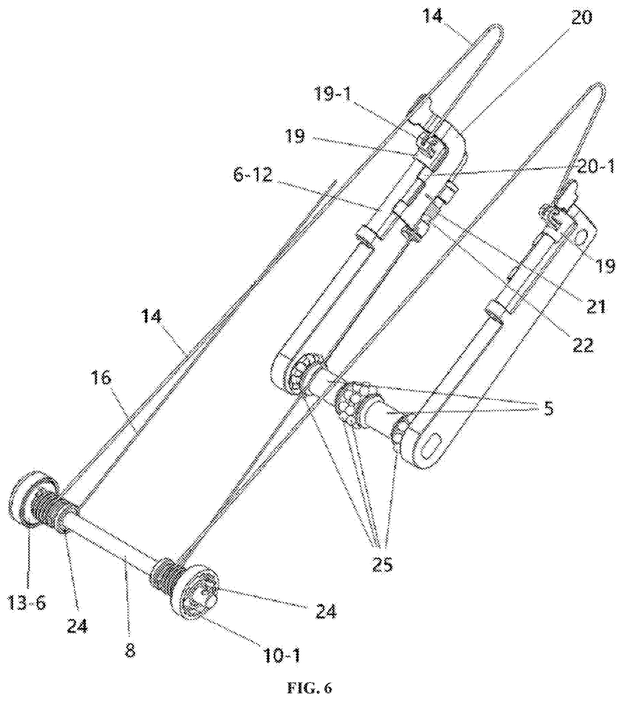

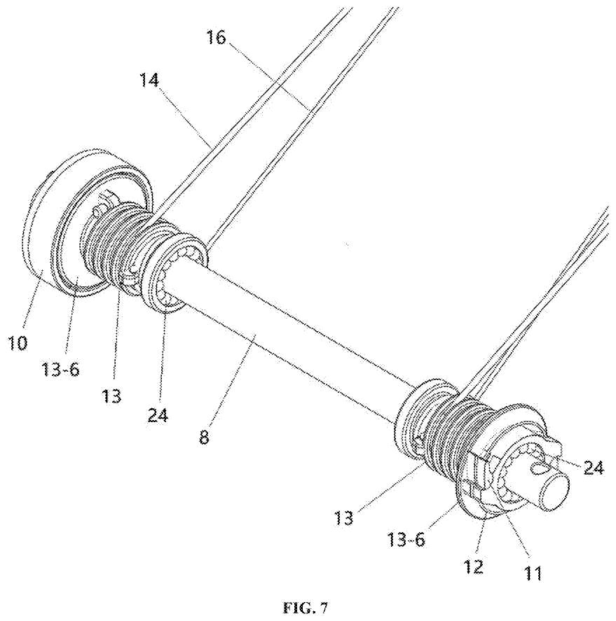

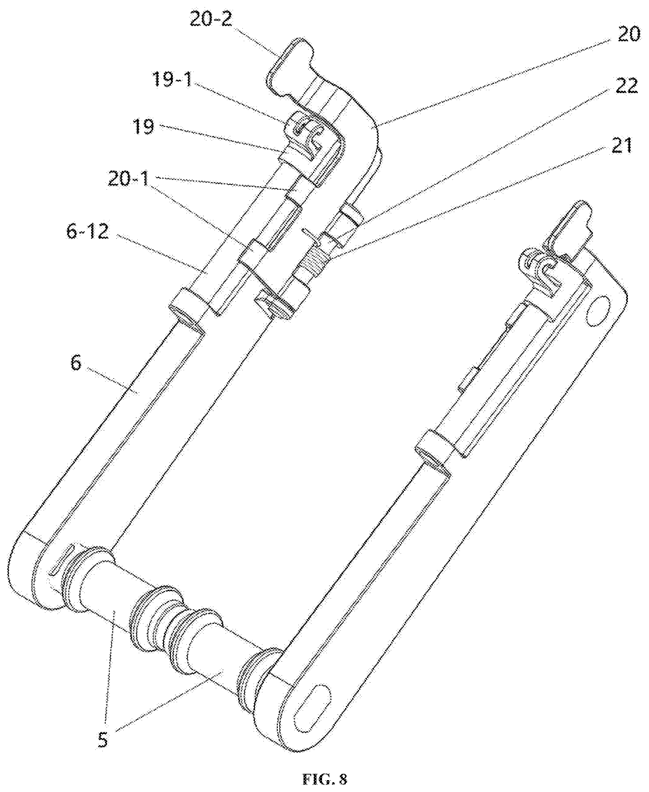

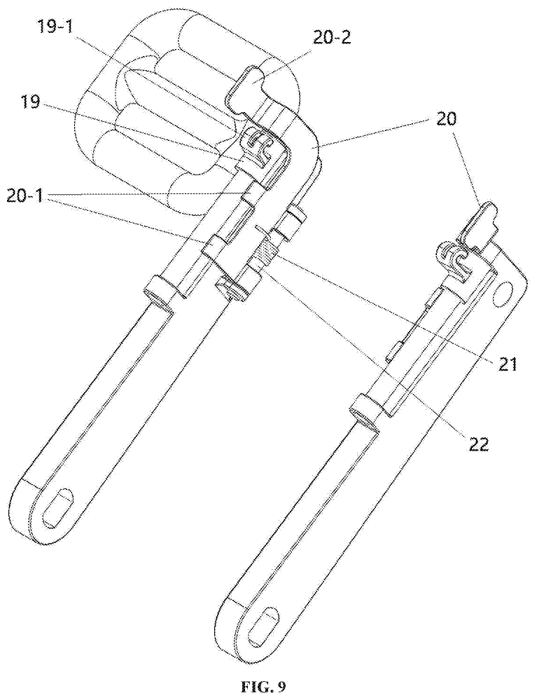

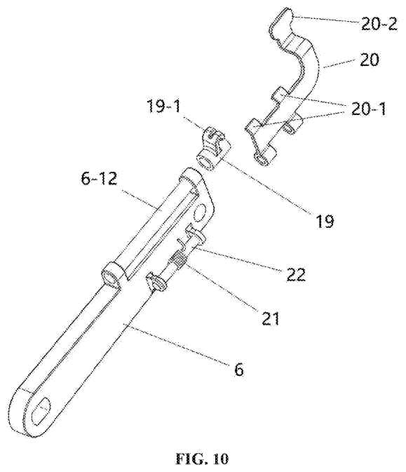

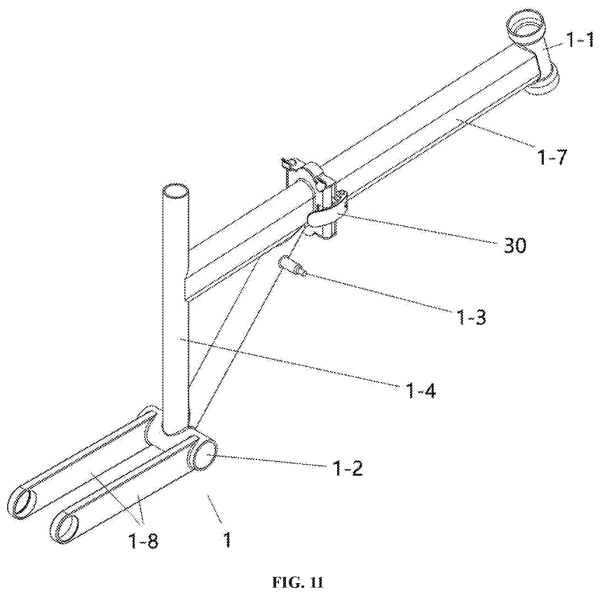

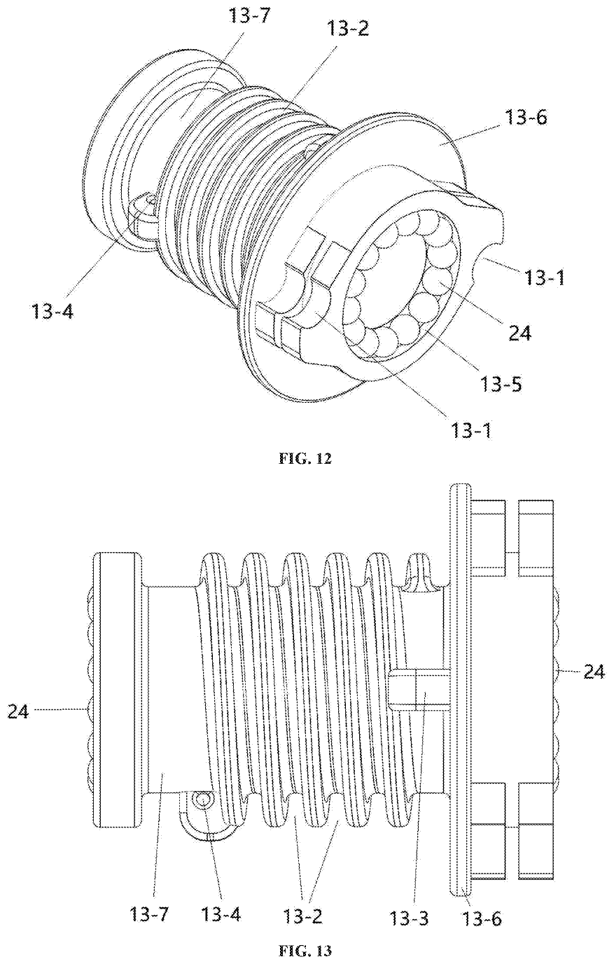

Please refer to FIGS. 1 to 17. A head tube 1-1 is disposed at a front end of the frame 1. A front fork 2 is pivotally connected within the head tube 1-1. A handlebar 4 is disposed at an upper end of the front fork 2, and a front wheel 3 is mounted to a lower end thereof.

A drive wheel mounting arm 1-8 is provided at a rear end of the frame 1. A drive wheel shaft 8 is pivotally connected to a rear end of the drive wheel mounting arm 1-8 via a pair of first bearings 23. A drive wheel 9 is fixedly secured to the drive wheel shaft 8, being tightly fitted onto a central portion thereof so as to be non-rotatable relative thereto.

Forward of the drive wheel 9, a bottom bracket shell 1-2 is provided. A seat tube 1-4 is disposed above the bottom bracket shell 1-2. A seat post 28 is disposed at an upper end of the seat tube 1-4, and a seat 29 is disposed at an upper end of the seat post 28. A top end of the seat post 28 is positioned 5 to 15 centimeters rearward of the bottom bracket shell 1-2, which facilitates more efficient force application during pedaling.

Two coaxial, independently rotatable crank axles 5 are mounted within the bottom bracket shell 1-2 via two pairs of ball retainers 25, a pair of outer cups 26, and a bidirectional inner cup 27. The bidirectional inner cup 27 is threaded into a transverse midsection of the bottom bracket shell 1-2, while the pair of outer cups 26 are threaded into opposite ends of the bottom bracket shell 1-2. An oscillating crank 6 is fixedly connected to an outer end of each crank axle 5. A pedal 7 is pivotally or fixedly attached to a distal region of each oscillating crank 6.

Two sets of transmission mechanisms are provided, left and right, respectively disposed outward of the pair of first bearings 23. The drive wheel 9 is mounted between the pair of first bearings 23. Each transmission mechanism comprises: a ratchet wheel 10 fixedly connected to the drive wheel shaft 8; a winding ring 13 pivotally connected on the drive wheel shaft 8; a winding chain 14 connected to the winding ring 13 and configured to be wound thereonto; and a return mechanism connected between the winding ring 13 and the frame 1. The return mechanism comprises a flexible wire 16 and a return spring 17. One end of the flexible wire 16 is connected to the winding ring 13, and an opposite end thereof is connected to the return spring 17. An opposite end of the return spring 17 is connected to the frame 1. The return spring 17 is a tension spring or a spiral spring.

In each transmission mechanism, the winding ring 13 is mounted outward of the corresponding first bearing 23—that is, the left winding ring 13 is positioned to the left of the left first bearing 23, and the right winding ring 13 is positioned to the right of the right first bearing 23. The ratchet wheel 10 is mounted outward of the winding ring 13. The ratchet wheel 10 includes ratchet teeth 10-1 and a ratchet sidewall 10-2, with the ratchet sidewall 10-2 fixedly secured to the drive wheel shaft 8.

A first pawl recess 13-1 is formed at an end of the winding ring 13 facing the ratchet wheel 10. A pawl 11 is installed within the first pawl recess 13-1 via an annular spring 12. The first pawl recess 13-1 projects into an interior of the ratchet wheel 10, and the pawl 11 engages the ratchet teeth 10-1. An opposite end of the winding ring 13 is provided with a flexible wire winding area 13-7 for winding the flexible wire 16 and a flexible wire attachment point 13-4 for connecting the flexible wire 16.

Adjacent to the first pawl recess 13-1, the winding ring 13 is provided with a sealing wall 13-6. The ratchet wheel 10 is provided with a sealing lip 10-3 on a side thereof facing the winding ring 13. The sealing wall 13-6 is laterally aligned with the sealing lip 10-3. A minute clearance is provided between an outer circumferential surface of the sealing wall 13-6 and an inner circumferential surface of the sealing lip 10-3, such that the pawl 11 and the annular spring 12 are disposed in a relatively sealed space defined by the ratchet wheel 10 and the sealing wall 13-6, thereby preventing ingress of mud and sand.

A first winding chain attachment point 13-3 for connecting the winding chain 14 is provided on the winding ring 13 adjacent to the sealing wall 13-6. A spiral groove 13-2 is formed on a circumferential surface of the winding ring 13 between the first winding chain attachment point 13-3 and the flexible wire winding area 13-7, for enabling the winding chain 14 to wind helically and sequentially onto the winding ring 13.

Ball cups 13-5 are formed at opposite ends of the winding ring 13, respectively, and steel balls 24 are disposed therein. The winding ring 13 is pivotally connected on the drive wheel shaft 8 between an inner ring of the first bearing 23 and the ratchet sidewall 10-2 via two rows of steel balls 24 disposed at opposite ends thereof.

A pulley shaft 1-3 is provided on a longitudinal beam 1-7 of the frame 1, positioned above a swing trajectory of a distal region of the oscillating crank 6. A fixed pulley 15 is pivotally connected on each end of the pulley shaft 1-3. One end of the winding chain 14 is connected to the first winding chain attachment point 13-3, and the other end is routed over the fixed pulley 15 and connected to the distal region of the oscillating crank 6.

Accordingly, when the pedal 7 is depressed downward, the winding chain 14—which is connected between the distal region of the oscillating crank 6 and the winding ring 13 via the fixed pulley 15 and is already wound around the winding ring 13—pulls the winding ring 13 to rotate in a forward direction. The winding ring 13 drives the ratchet wheel 10 and the drive wheel shaft 8 to rotate synchronously via the pawl 11, thereby providing forward driving power to the drive wheel 9. At the same time, the flexible wire 16 is wound around the winding ring 13 and pulls the connected return spring 17, thereby storing energy.

When pedaling on the pedal 7 ceases, the return spring 17 releases energy and pulls the winding ring 13, via the flexible wire 16 wound therearound, to idle in a reverse direction relative to the drive wheel shaft 8, such that the winding chain 14 rewinds onto the winding ring 13 along the spiral groove 13-2, thereby driving the distal region of the connected oscillating crank 6 to swing upward. This reciprocating cycle repeats.

A gear-shifting mechanism is provided at a distal region of the oscillating crank 6. The gear-shifting mechanism comprises: a slide rail 6-12 disposed on the oscillating crank 6; a sliding sleeve 19 slidably mounted on the slide rail 6-12; a locking lever 20 for locking the sliding sleeve 19 at different gear positions; and a torsion return spring 21 connected between the locking lever 20 and the oscillating crank 6, biasing the locking lever 20 toward a locked position. The sliding sleeve 19 is provided with a third winding chain attachment point 19-1, and a second end of the winding chain 14 is connected to the third winding chain attachment point 19-1.

The locking lever 20 is pivotally connected to the oscillating crank 6 via a lever shaft 22. A distal region of the locking lever 20 is provided with an actuation tab 20-2 and a plurality of limit stops 20-1. A spacing between adjacent limit stops 20-1 corresponds to a length of the sliding sleeve 19. The torsion return spring 21 biases the limit stops 20-1 such that distal ends thereof press against the slide rail 6-12, thereby preventing the sliding sleeve 19 from moving along the slide rail 6-12.

To shift from a low gear to a high gear, when the distal region of the oscillating crank 6 is at a high position (pointing obliquely upward), a rider nudges the actuation tab 20-2 inward with a foot. This causes the locking lever 20 to rotate against a bias of the torsion return spring 21, such that the distal ends of the limit stops 20-1 disengage from the slide rail 6-12, and the sliding sleeve 19 slides along the slide rail 6-12 toward an end of the oscillating crank 6 distal from the crank axle 5 under a pulling force from the winding chain 14. Before the sliding sleeve 19 slides to a predetermined gear position, the actuation tab 20-2 is released, and the sliding sleeve 19 is locked at a desired gear position by the locking lever 20.

To shift from a high gear to a low gear, when the distal region of the oscillating crank 6 is depressed to a lower position (pointing obliquely downward), the rider nudges the actuation tab 20-2 inward with the foot. The locking lever 20 rotates against a bias of the torsion return spring 21, such that the distal regions of the limit stops 20-1 disengage from the slide rail 6-12, and the sliding sleeve 19 slides along the slide rail 6-12 toward a proximal region of the oscillating crank 6 relative to the crank axle 5 under a pulling force from the winding chain 14, thereby easily completing a shift from a high gear to a low gear.

To allow the frame 1 to be folded, a folding buckle 30 is provided at a middle portion of a longitudinal beam 1-7 of the frame 1.

### Embodiment 2

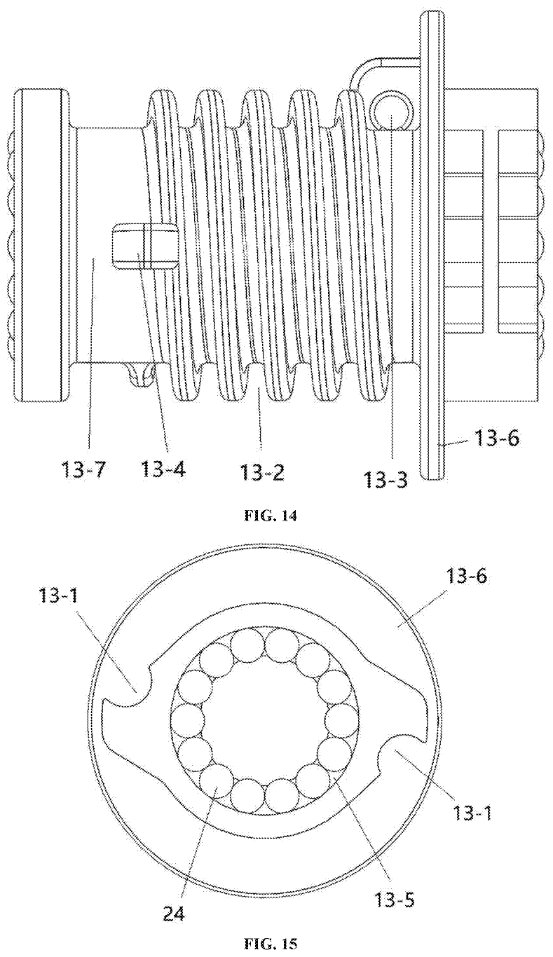

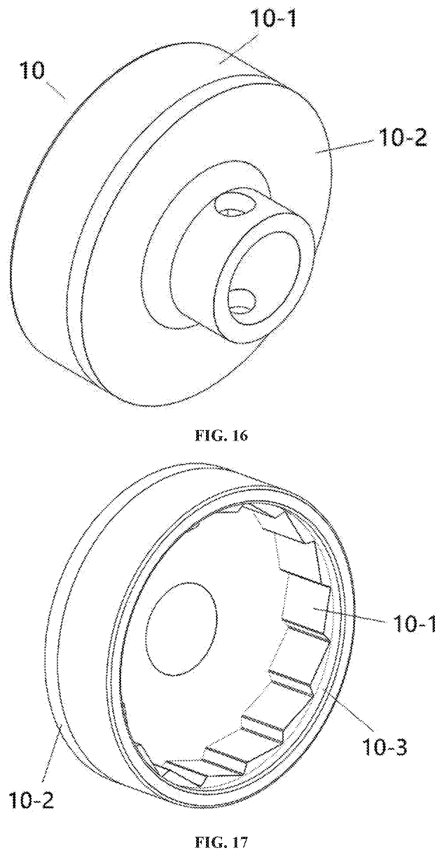

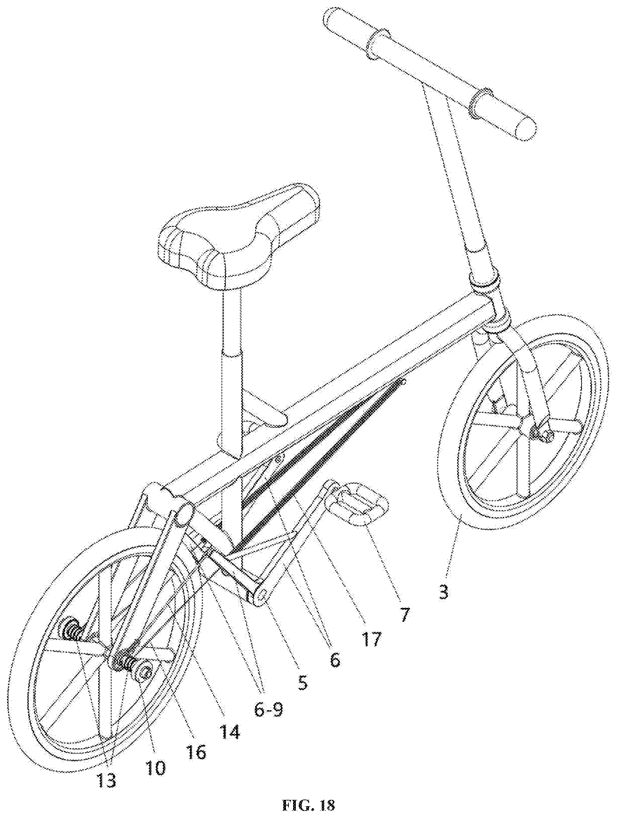

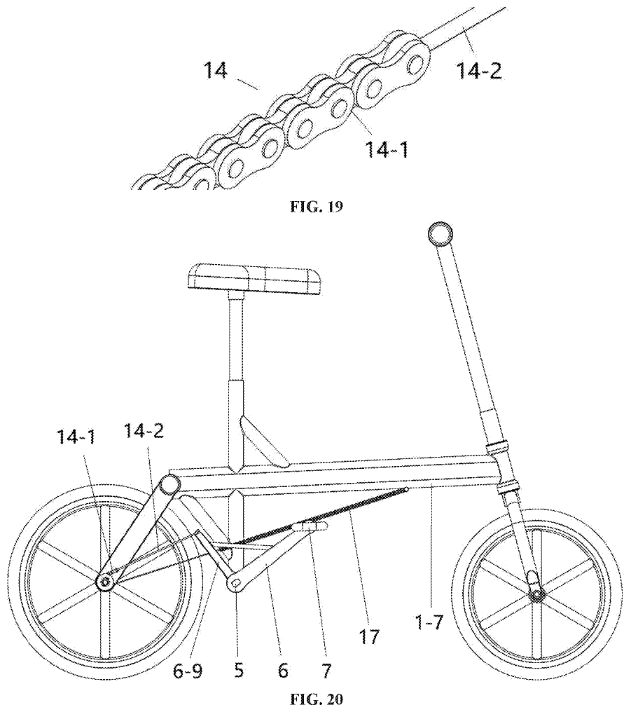

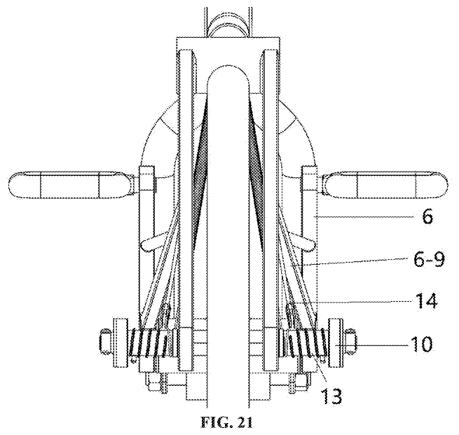

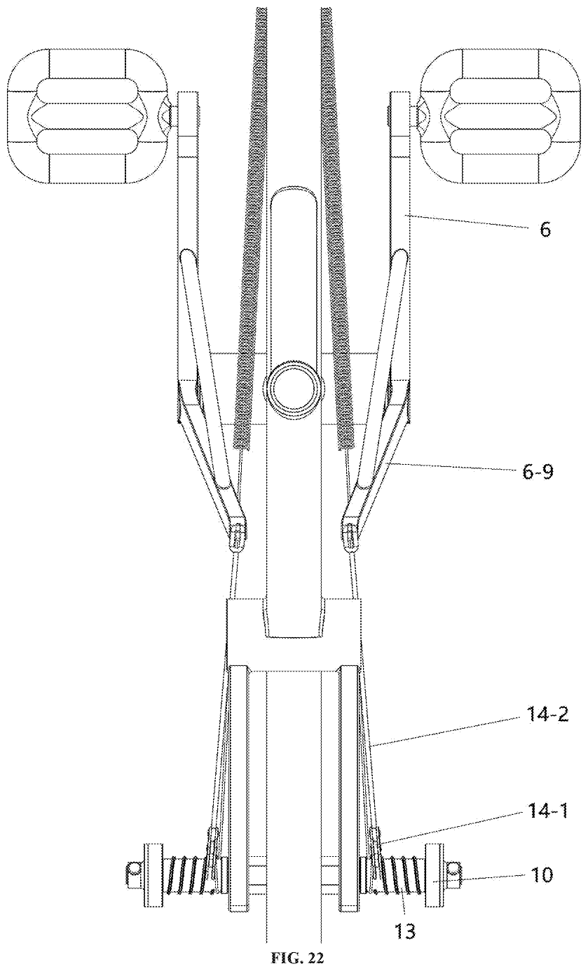

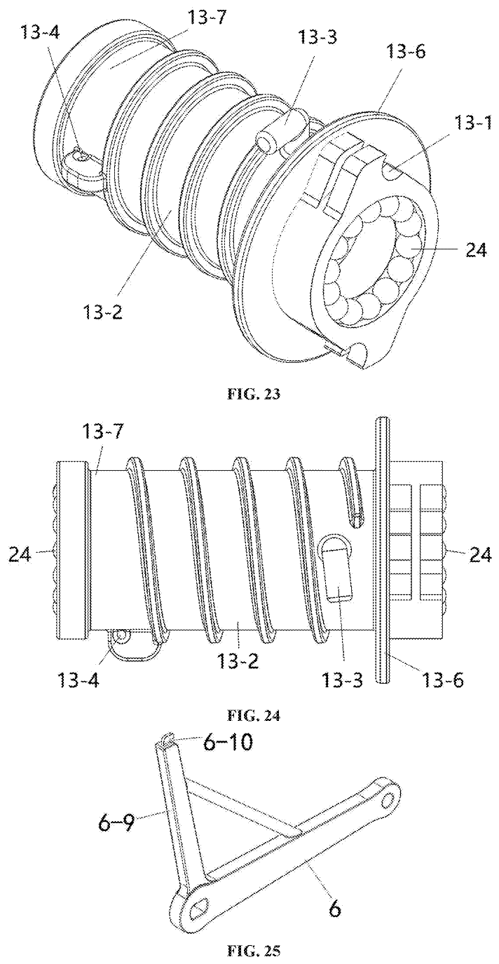

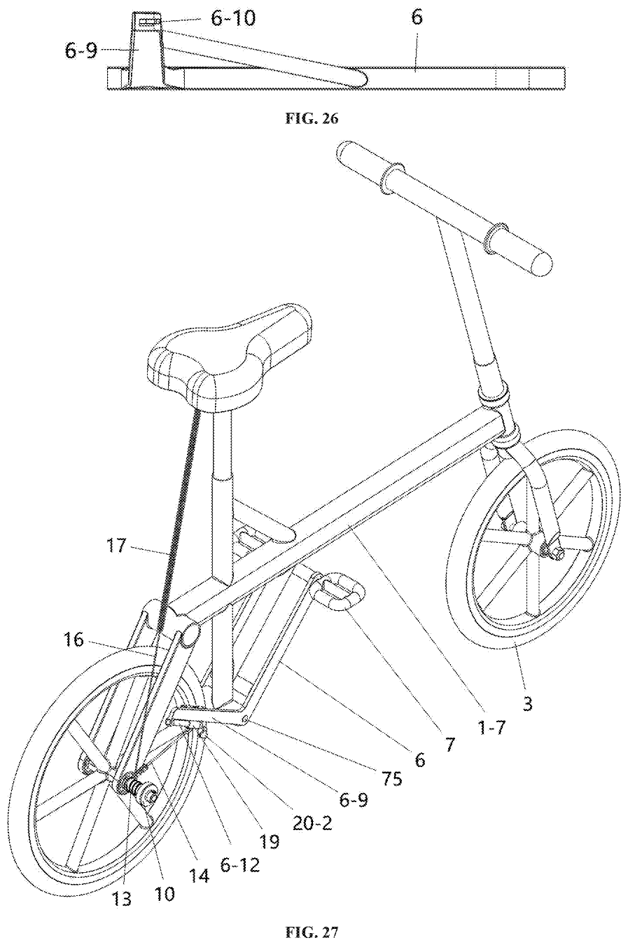

Please refer to FIGS. 18 to 26. This embodiment includes two sets of transmission mechanisms disposed on both sides of the frame 1. The frame 1 is provided with a bottom bracket shell 1-2. Two crank axles 5 are pivotally connected in the bottom bracket shell 1-2. An oscillating crank 6 is fixedly connected to an outer end of each crank axle 5. Each oscillating crank 6 is provided with a winding chain connecting arm 6-9. A distal region of the winding chain connecting arm 6-9 is provided with a fifth winding chain attachment point 6-10. The second end of the winding chain 14 is connected to the fifth winding chain attachment point 6-10 at the distal region of the winding chain connecting arm 6-9 on the same side.

When the oscillating crank 6 is swung to a horizontal state, the distal region of the oscillating crank 6 faces the front of the frame 1. At this time, the distal region of the winding chain connecting arm 6-9 points upward and is slightly inclined inward. Accordingly, when the distal region of the oscillating crank 6 swings downward within a predetermined angular range, the distal region of the winding chain connecting arm 6-9 pulls the second end of the winding chain 14 forward to drive the winding ring 13 to rotate.

Since the distal region of the winding chain connecting arm 6-9 always pulls the second end of the winding chain 14 forward, the second end of the winding chain 14 is always maintained in a tangential direction (the second end of the winding chain 14 is always in an optimal lateral position) both when the winding chain 14 disengages from the winding ring 13 and when it rewinds onto the winding ring 13. This ensures that the winding chain 14 can accurately enter the spiral groove 13-2 of the winding ring 13 along a set path during rewinding.

Alternatively, the winding ring 13 in Embodiment 2 can be configured without the spiral groove 13-2, and the winding chain 14 can still be accurately wound onto the winding ring 13 along a set path when rewinding.

In Embodiment 2, the winding chain 14 is composed of a chain portion 14-1 and a rigid steel wire portion 14-2. The end connected to the winding ring 13 and configured to wind around the winding ring 13 is the chain portion 14-1, and the end connected to the distal region of the winding chain connecting arm 6-9 and not configured to wind around the winding ring 13 is the rigid steel wire portion 14-2. When the chain portion 14-1 winds around the winding ring 13 along a set path, the bottom portion of the chain portion 14-1 fits with the circumferential surface of the winding ring 13, so that the chain portion 14-1 can better fit against the winding ring 13 during winding.

In FIGS. 18, 21 and 22, for convenience of illustration, only the end of the chain portion 14-1 connected to the rigid steel wire portion 14-2 is shown, and the portion wound around the winding ring 13 is omitted (the starting end of the chain portion 14-1 is connected to the first winding chain attachment point 13-3).

### Embodiment 3

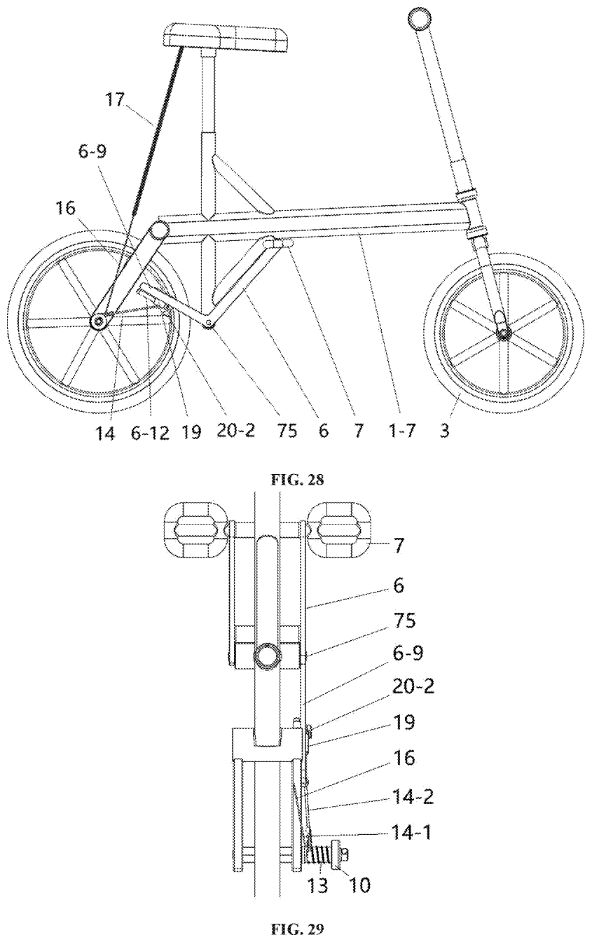

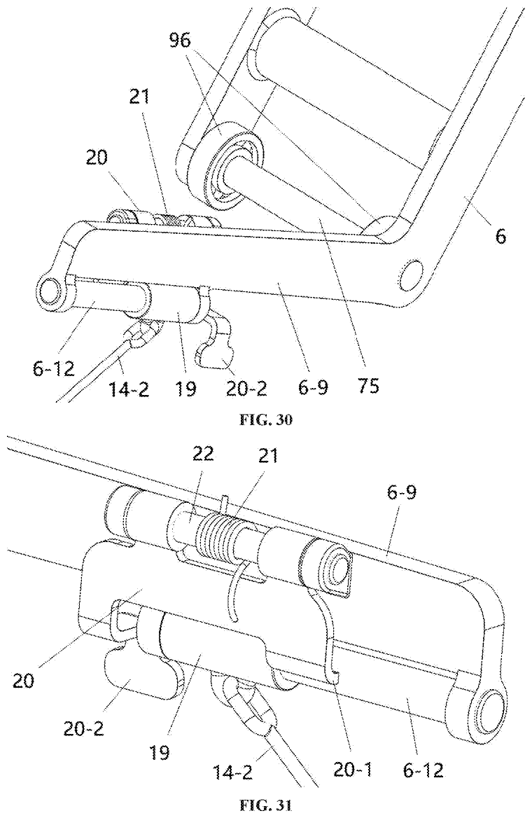

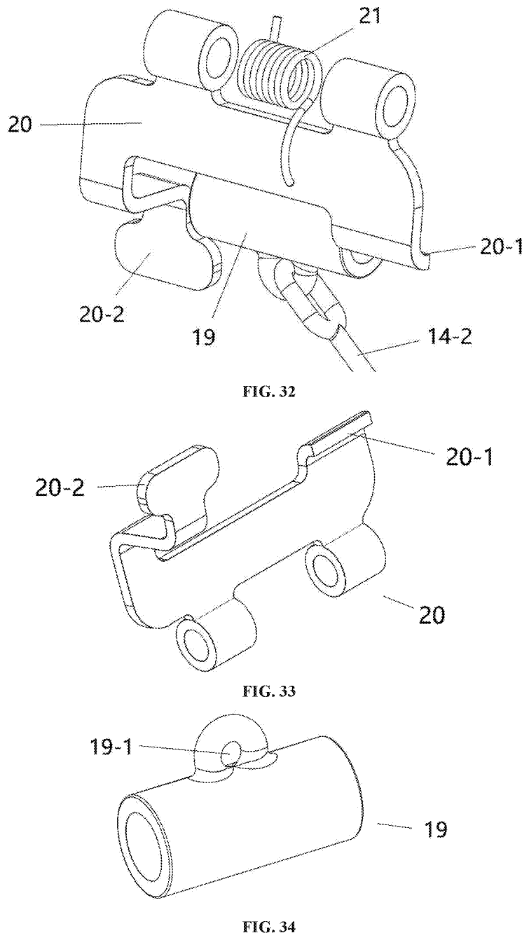

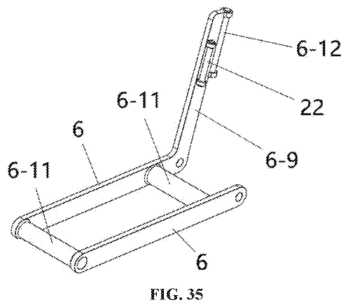

Please refer to FIGS. 27 to 35. This embodiment includes only a single set of transmission mechanisms disposed on the right side of the frame 1. In this embodiment, the frame 1 is provided with a bottom bracket shell 1-2.

A single crank axle 75 is pivotally connected in the bottom bracket shell 1-2. An oscillating crank 6 is fixedly connected to each end of the crank axle 75, and only the right oscillating crank 6 is provided with a winding chain connecting arm 6-9.

A gear-shifting mechanism is provided at the distal region of the winding chain connecting arm 6-9. The gear-shifting mechanism comprises: a slide rail 6-12 disposed at the distal region of the winding chain connecting arm 6-9; a sliding sleeve 19 slidably mounted on the slide rail 6-12; a locking lever 20 for locking the sliding sleeve 19 at different gear positions on the slide rail 6-12; and a torsion return spring 21 connected between the locking lever 20 and the winding chain connecting arm 6-9 to bias the locking lever 20 toward a locked state.

The sliding sleeve 19 is provided with a third winding chain attachment point 19-1, and the second end of the winding chain 14 is connected to the third winding chain attachment point 19-1 on the sliding sleeve 19.

The left and right oscillating cranks 6 are connected into an integral body via two middle cross tubes 6-11, thereby greatly reducing elastic deformation of the oscillating cranks 6 during pedaling and minimizing energy loss.

### Embodiment 4

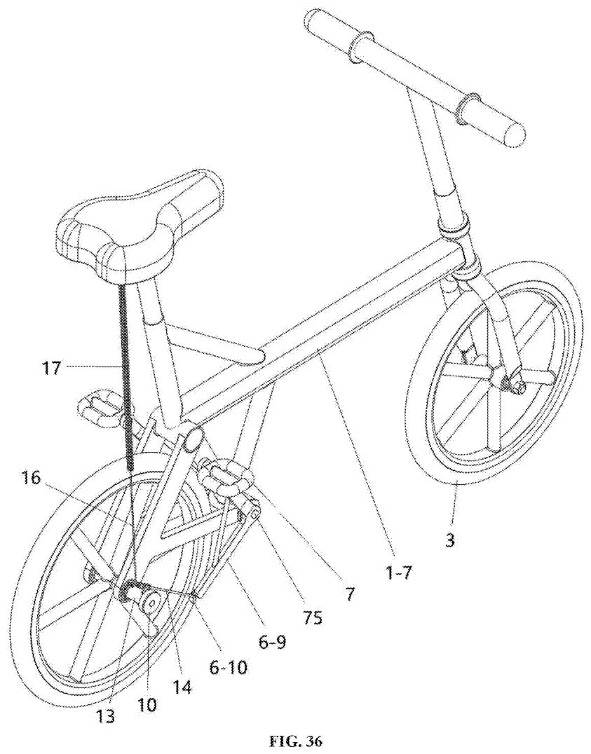

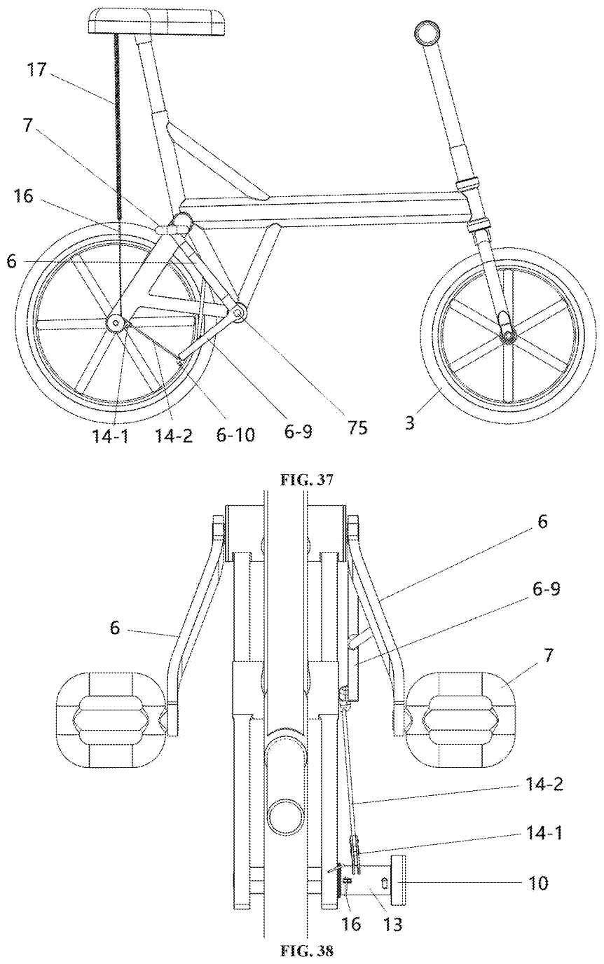

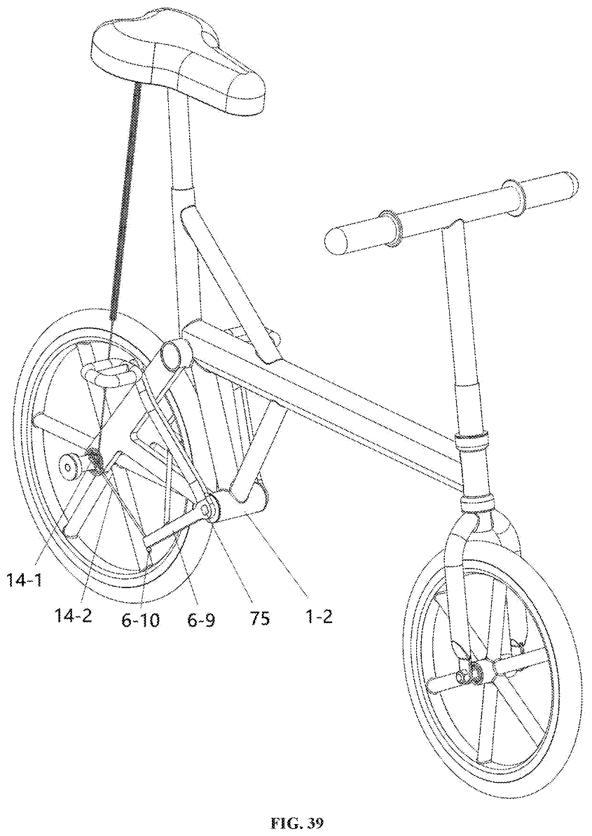

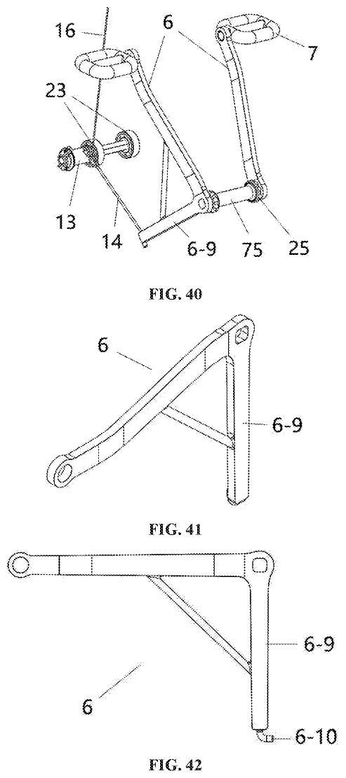

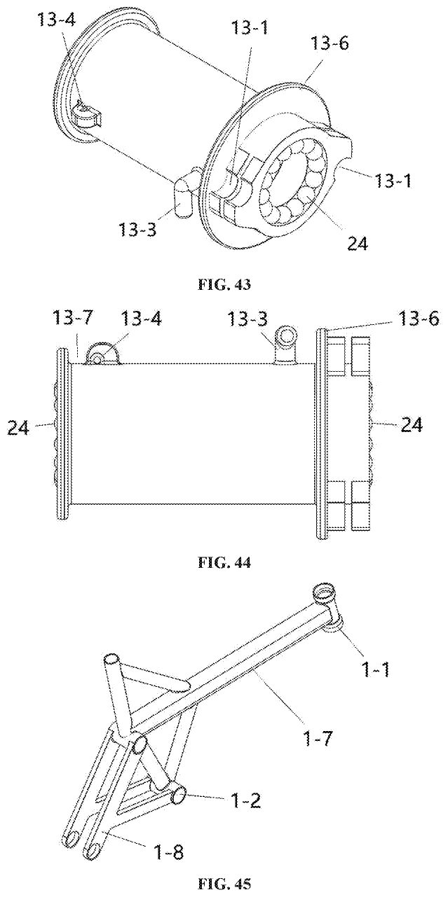

Please refer to FIGS. 36 to 45. Embodiment 4 is similar to Embodiment 3. The main difference is that the distal region of the oscillating crank 6 faces the front of the frame 1 in Embodiment 3, while the distal region of the oscillating crank 6 faces the rear of the frame 1 in Embodiment 4. This embodiment is not provided with a gear-shifting mechanism. A fifth winding chain attachment point 6-10 is provided at the distal region of the winding chain connecting arm 6-9, and the second end of the winding chain 14 is connected to the fifth winding chain attachment point 6-10. When the distal region of the oscillating crank 6 points directly rearward, the distal region of the winding chain connecting arm 6-9 points downward.

In this embodiment, the longitudinal distance between the pedal 7 and the drive wheel shaft 8 is very short. During riding, the pedaling force acts substantially directly on the drive wheel 9, which greatly reduces the load on the frame longitudinal beam 1-7, prevents energy absorption caused by elastic deformation of the frame longitudinal beam 1-7 during riding and pedaling, and can appropriately reduce the distance between the front and rear wheels. In Embodiment 4, the winding ring 13 is not provided with the spiral groove 13-2.

In the drawings, for convenience of illustration, only the end of the chain portion 14-1 connected to the rigid steel wire portion 14-2 is shown, and the portion wound around the winding ring 13 is omitted (the starting end of the chain portion 14-1 is connected to the first winding chain attachment point 13-3).

### Embodiment 5

Embodiment 5 is similar to Embodiment 4, and the main difference is that Embodiment 5 is provided with two sets of transmission mechanisms, arranged on left and right sides.

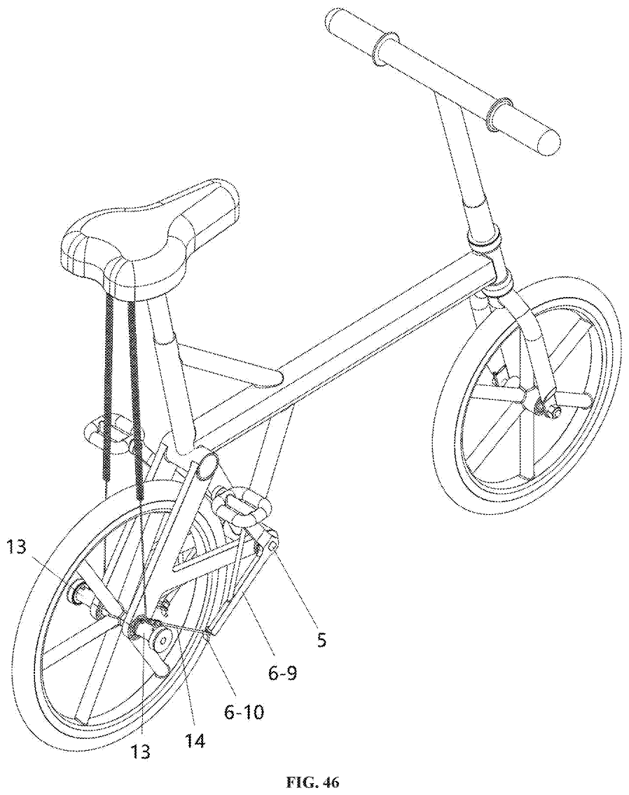

Please refer to FIGS. 46 and 47. In Embodiment 5, left and right independently rotatable crank axles 5 are pivotally connected in the bottom bracket shell 1-2. Left and right oscillating cranks 6 are fixedly connected to outer ends of the left and right crank axles 5, respectively. The left and right oscillating cranks 6 are respectively provided with winding chain connecting arms 6-9. A fifth winding chain attachment point 6-10 is provided at the distal region of each winding chain connecting arm 6-9. The second end of the winding chain 14 is connected to the fifth winding chain attachment point 6-10 at the distal region of the winding chain connecting arm 6-9 on the corresponding side.

### Embodiment 6

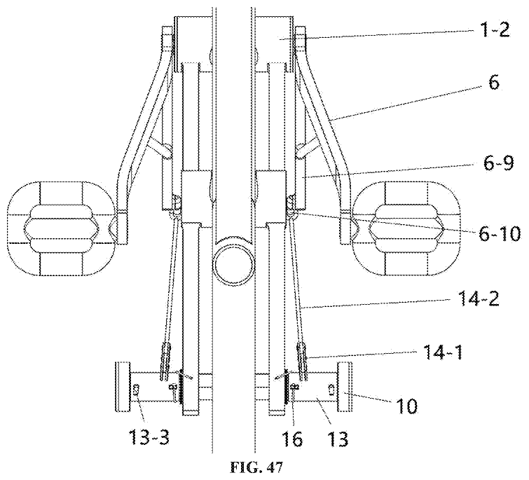

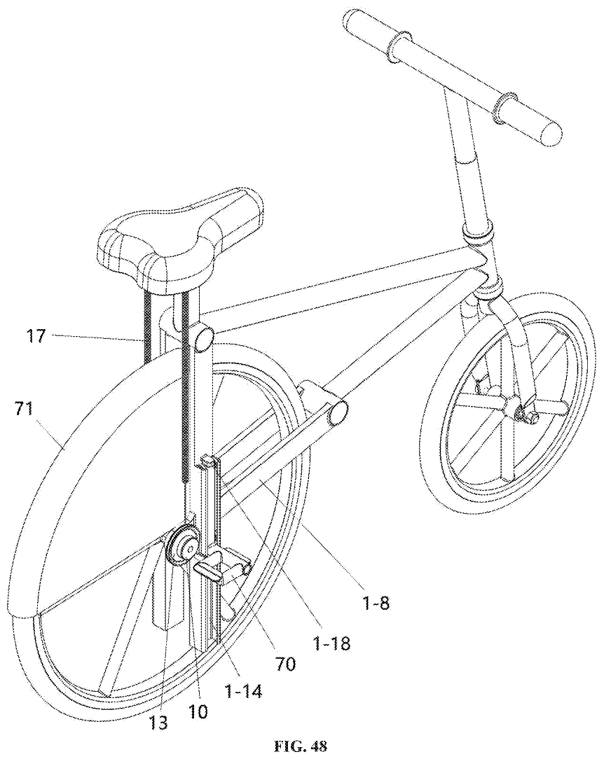

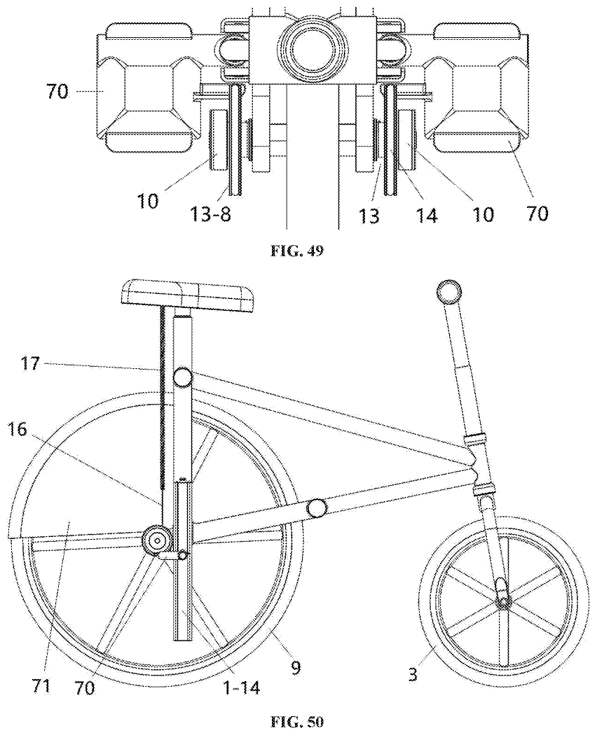

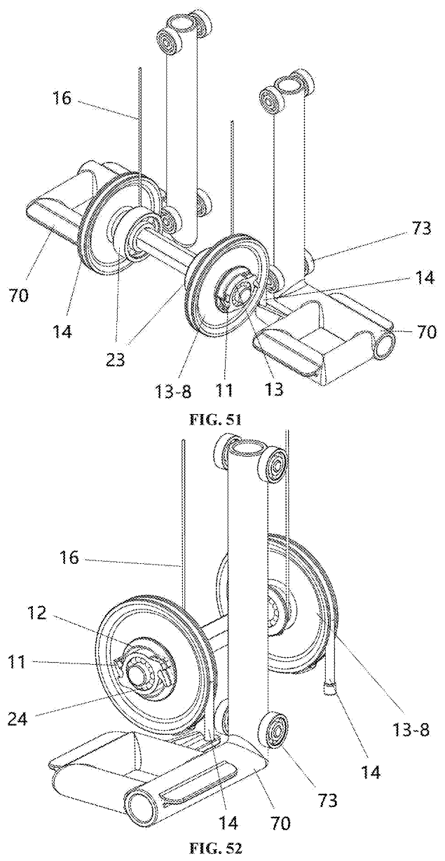

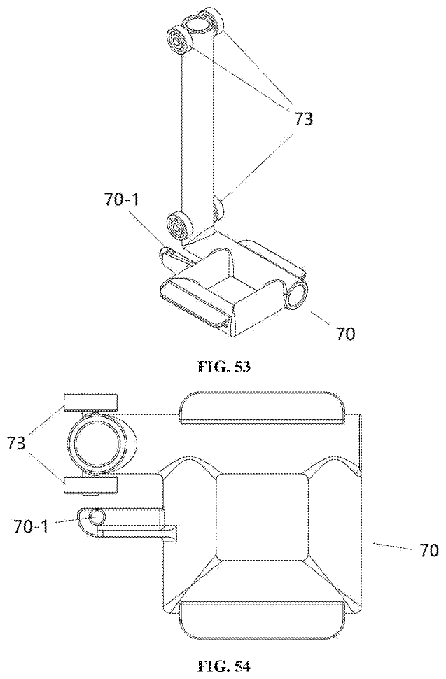

Please refer to FIGS. 48 to 58. This embodiment includes two sets of transmission mechanisms, one on each side of the frame 1. The drive wheel shaft 8 is pivotally connected to the frame 1 via a pair of first bearings 23, and the drive wheel 9 is fixedly connected to the drive wheel shaft 8. A pair of guide grooves 1-14 are provided on the frame 1, each located forward of a respective end of the drive wheel shaft 8.

The pedal device consists of left and right reciprocating pedals 70. Four guide rollers 73 are pivotally connected to each reciprocating pedal 70. The guide rollers 73 extend into the guide grooves 1-14. Side walls of the guide grooves 1-14 guide and constrain the guide rollers 73, thereby guiding the reciprocating pedals 70 to move up and down along a trajectory defined by the guide grooves 1-14. Each reciprocating pedal 70 is provided with a fourth winding chain attachment point 70-1, and the second end of the winding chain 14 is connected to the fourth winding chain attachment point 70-1 on the reciprocating pedal 70 on the same side. A limit plate 1-18 is provided at an upper end of each guide groove 1-14 to restrict upward movement of the reciprocating pedal 70.

This configuration employs a linear pedaling motion, which eliminates the problem of a varying effective moment arm inherent in rotary pedaling. Moreover, the pedaling force acts directly on the drive wheel 9, achieving an energy utilization efficiency of approximately 98%.

In Embodiment 6, the winding ring 13 is provided with a winding disk 13-8. A circumferential surface of the winding disk 13-8 defines a winding chain winding area 13-9 for winding the winding chain 14, and the winding chain winding area 13-9 is provided with a first winding chain attachment point 13-3. The winding chain 14 can be wound around the winding chain winding area 13-9 for up to one complete turn. Consequently, each depression of a reciprocating pedal 70 can drive the drive wheel 9 to rotate up to one full revolution. The circumference of the winding disk 13-8 is slightly larger than the maximum stroke of the reciprocating pedal 70.

Alternatively, a spiral groove 13-2 may be formed on the circumferential surface of the winding disk 13-8, allowing the winding chain 14 to be wound along the spiral groove 13-2 for more than one turn around the winding disk 13-8. This enables one power stroke of the reciprocating pedal 70 to drive the drive wheel 9 through more than one revolution, thereby permitting a reduction in the diameter of the winding disk 13-8. A trade-off is that the axial width of the winding disk 13-8 must be increased. A fender 71 is provided at the drive wheel 9.

### Embodiment 7

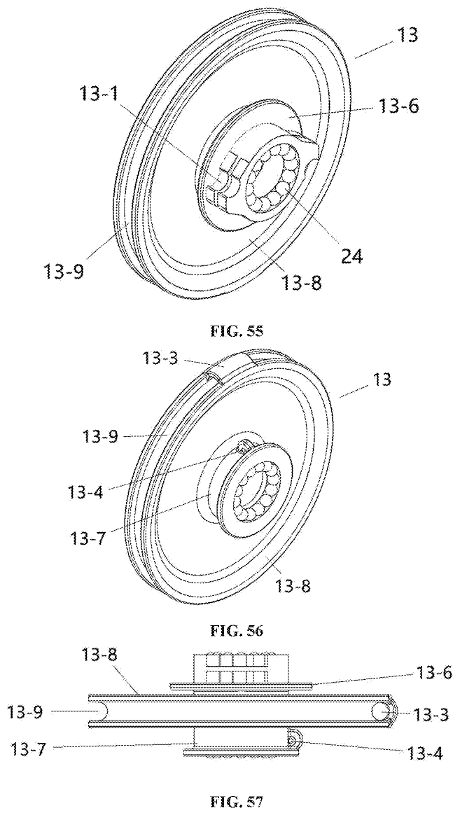

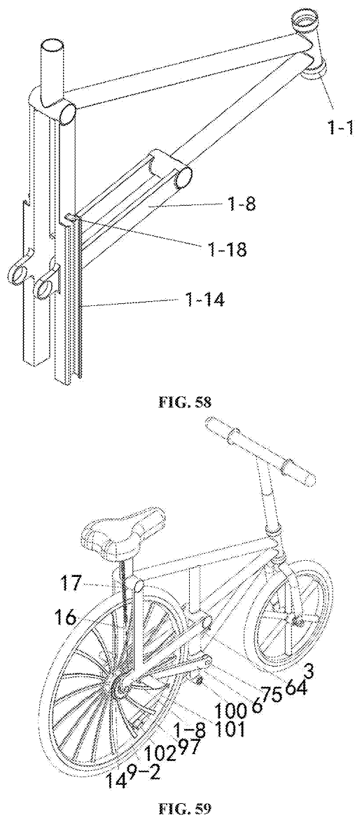

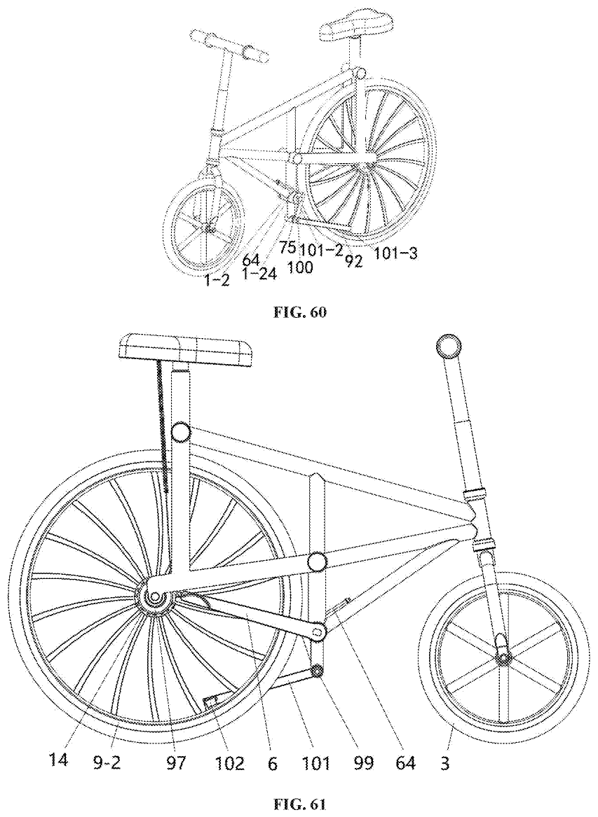

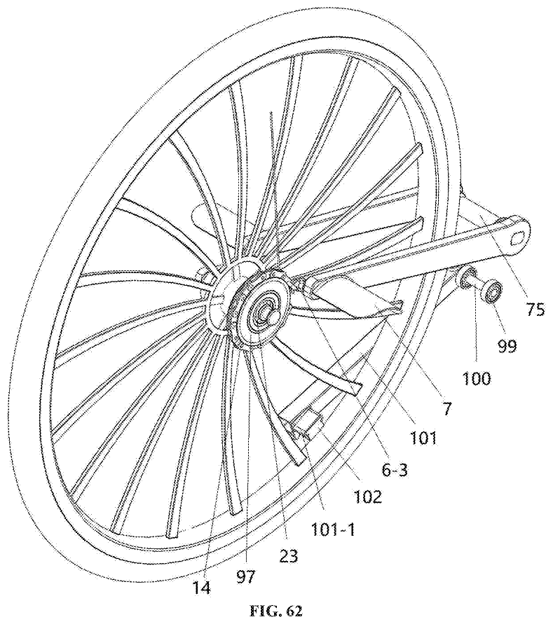

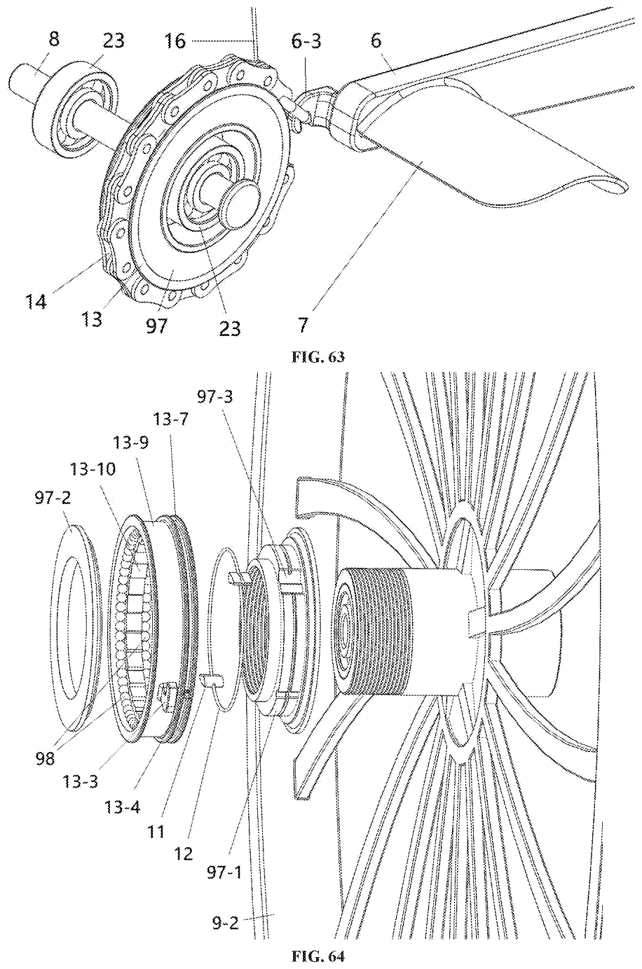

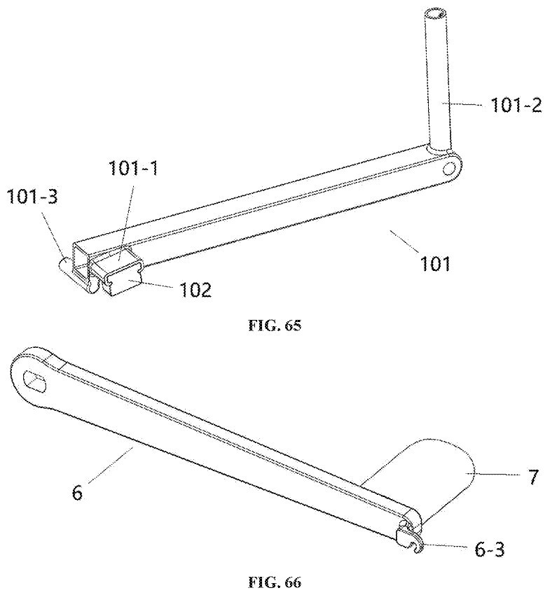

Please refer to FIGS. 59 to 66. This embodiment includes a single set of transmission mechanisms disposed on the right side of the drive wheel 9. The frame 1 is provided with a bottom bracket shell 1-2, and a single crank axle 75 is pivotally connected in the bottom bracket shell 1-2. An oscillating crank 6 is fixedly connected to each end of the crank axle 75, and a pedal 7 is fixedly or pivotally connected to the distal region of each oscillating crank 6. The distal region of the oscillating crank 6 faces the rear of the frame 1. When the distal region of the oscillating crank 6 is returned to a return high position under the pulling force transmitted from the return spring 17 via the winding ring 13 and the winding chain 14, a terminal portion of the distal end is adjacent to the winding ring 13.

Accordingly, the pedaling force acts directly on the drive wheel 9 via the winding ring 13 and the drive wheel shaft 8, thereby reducing the load on the frame 1 and lowering its rigidity requirement, contributing to a reduction in overall vehicle weight. A second winding chain attachment point 6-3 is provided at the distal end of the right oscillating crank 6, and the second end of the winding chain 14 is connected to the second winding chain attachment point 6-3.

The drive wheel shaft 8 is fixedly connected to the drive wheel mounting arm 1-8 disposed at the rear end of the frame 1, and the drive wheel 9 is pivotally connected to the drive wheel shaft 8 via a pair of first bearings 23 or two rows of steel balls.

In Embodiment 7, the winding ring 13 drives the drive wheel 9 unidirectionally via a winding inner ring 97 and the pawl 11. The winding inner ring 97 is fixedly connected to the drive wheel 9 and comprises an inner ring body 97-1 and an inner ring cover 97-2. The winding ring 13 is pivotally connected to the winding inner ring 97 via two rows of small steel balls 98.

A second pawl recess 97-3 is formed on the outer circumferential surface of the winding inner ring 97. The pawl 11 is mounted in the second pawl recess 97-3 via an annular spring 12. Second ratchet teeth 13-10 are formed on the inner circumferential surface of the winding ring 13. The pawl 11 meshes with the second ratchet teeth 13-10, such that the winding ring 13 is capable only of unidirectional rotation relative to the winding inner ring 97.

A winding chain winding area 13-9 for winding the winding chain 14 and a first winding chain attachment point 13-3 for connecting the winding chain 14 are provided on the right side of the circumferential surface of the winding ring 13. A flexible wire winding area 13-7 for winding the flexible wire 16 and a flexible wire attachment point 13-4 for connecting the flexible wire 16 are provided on the left side of the circumferential surface.

In Embodiment 7, a cross shaft tube 1-24 is disposed below the bottom bracket shell 1-2. A second foot brake device is disposed rearward and below the cross shaft tube 1-24. The second foot brake device comprises: a brake cross shaft 100 pivotally connected to the cross shaft tube 1-24 via a pair of third bearings 99 (or two rows of steel balls); a brake arm 101 fixedly connected to the left end of the brake cross shaft 100; a brake pad 102 mounted on the inner side of the distal end of the brake arm 101; and a brake return spring 64 connected between the brake arm 101 and the frame 1.

The pivotal end of the brake arm 101 is provided with a push tube 101-2. The brake return spring 64 biases the distal end of the brake arm 101, which points rearward and downward, to swing upward, so that the upper end of the push tube 101-2 is pressed forward against the bottom bracket shell 1-2. When the upper end of the push tube 101-2 is pressed against the bottom bracket shell 1-2, the distal end of the brake arm 101 points toward the rim 9-2 of the drive wheel 9 close to the ground, and the brake pad 102 is positioned 2 to 8 millimeters above the rim 9-2.

A brake pad base 101-1 is provided on the inner side of the distal end of the brake arm 101, and the upper end of the brake pad 102 is fitted into the brake pad base 101-1. A cross stopper 101-3 is provided on the outer side of the distal end. When the distal end of the oscillating crank 6 swings downward to a lower position, it pushes the cross stopper 101-3 downward, causing the distal end of the brake arm 101 to swing downward, and the brake pad 102 presses against the rim 9-2 of the drive wheel 9 to automatically complete the braking process.

In Embodiment 7, the return mechanism may comprise a flexible wire 16 and a return spring 17. One end of the flexible wire 16 is connected to the winding ring 13, and the other end is connected to the return spring 17. The other end of the return spring 17 is connected to the seat 29.

Alternatively, the return mechanism may consist solely of a return spring 17, which may be a tension spring. One end of the return spring 17 is connected to the winding ring 13, and the other end is connected to the seat 29.

### Embodiment 8

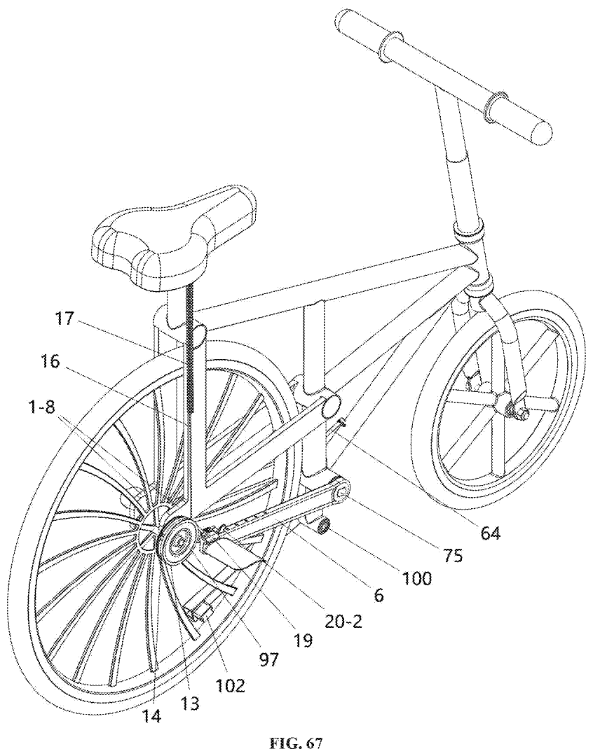

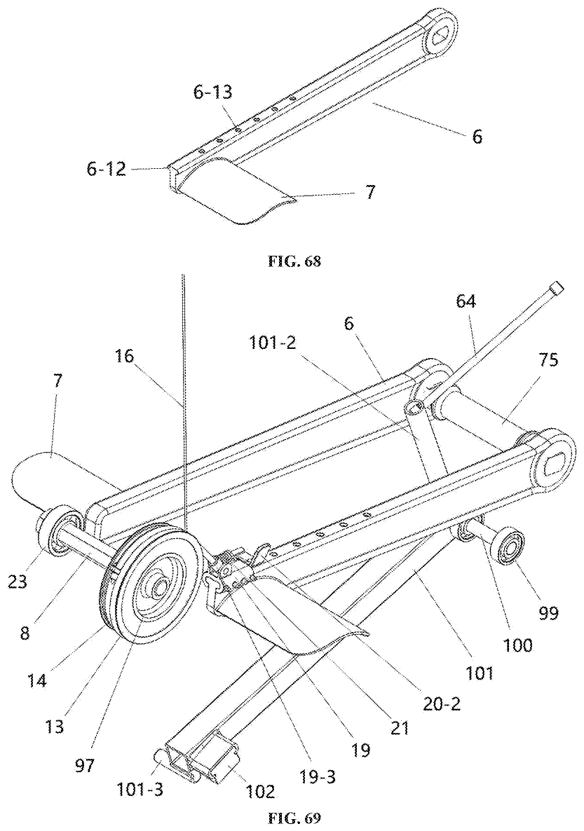

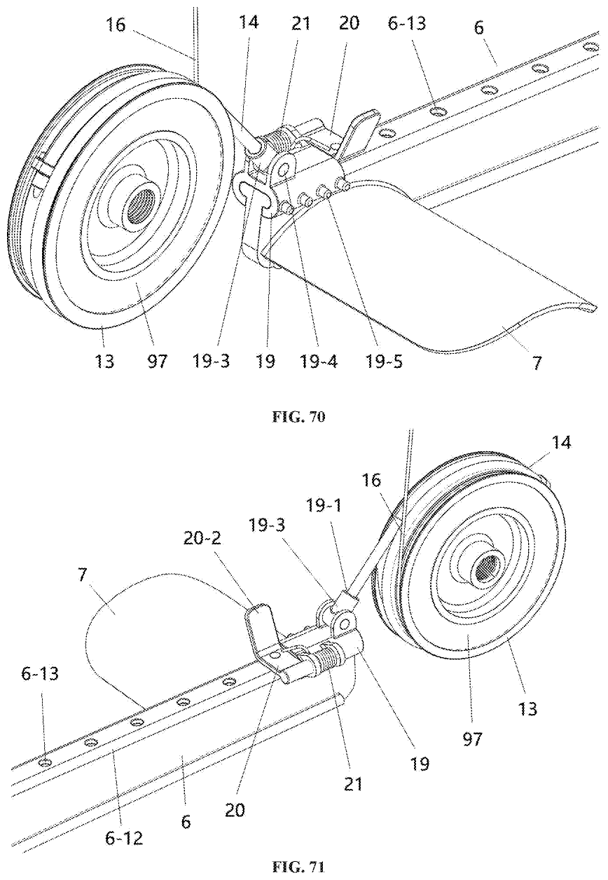

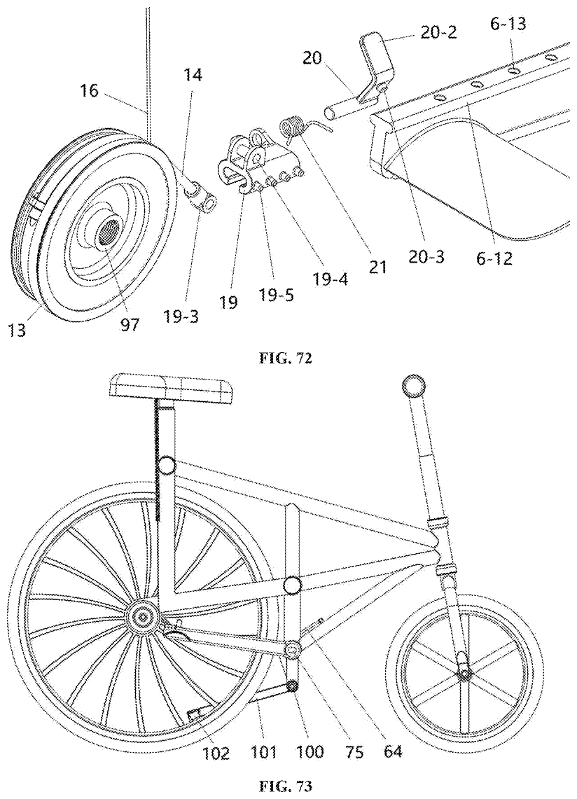

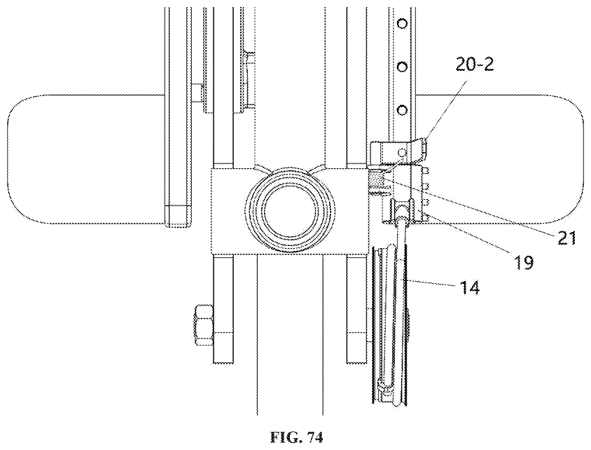

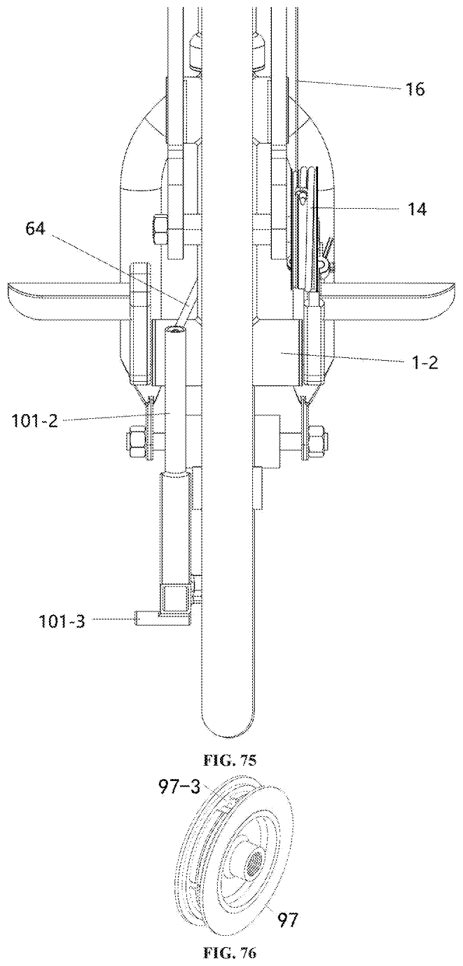

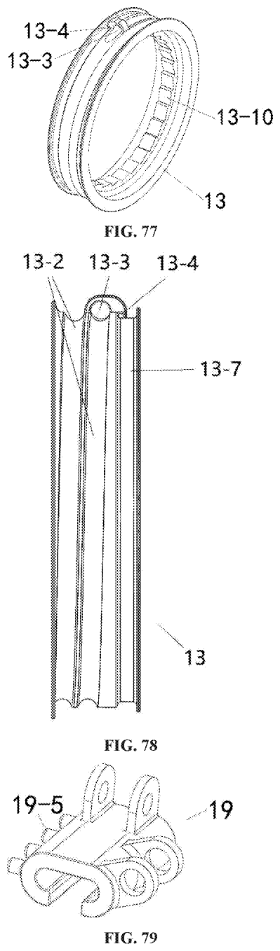

Please refer to FIGS. 67 to 79. Embodiment 8 is similar to Embodiment 7. The main difference is that in Embodiment 8, the drive wheel shaft 8 is pivotally connected to an end of the drive wheel mounting arm 1-8 disposed at the rear end of the frame 1 via a pair of first bearings 23, and the drive wheel 9 is fixedly connected to the drive wheel shaft 8. The right end of the drive wheel shaft 8 extends to the right side of the drive wheel mounting arm 1-8, and the winding inner ring 97 is fixedly connected to the right end of the drive wheel shaft 8.

The spiral groove 13-2 for helically winding the winding chain 14 is provided on the right side of the circumferential surface of the winding ring 13, and the first winding chain attachment point 13-3 for connecting the winding chain 14 is provided at the starting end of the spiral groove 13-2. The flexible wire winding area 13-7 for winding the flexible wire 16 and the flexible wire attachment point 13-4 for connecting the flexible wire 16 are provided on the left side of the circumferential surface of the winding ring 13.

In Embodiment 8, a gear-shifting mechanism is provided at the distal region of the right oscillating crank 6. The gear-shifting mechanism includes: a slide rail 6-12 disposed on the oscillating crank 6; a sliding sleeve 19 slidably mounted on the slide rail 6-12 and movable along the slide rail 6-12; a locking lever 20 configured to lock the sliding sleeve 19 at different gear positions on the slide rail 6-12; and a torsion return spring 21 that biases the locking lever 20 toward a closed, locked state.

A plurality of locking recesses 6-13 are provided on the oscillating crank 6 at predetermined intervals. The locking lever 20 is pivotally connected to the sliding sleeve 19. The torsion return spring 21 is connected between the sliding sleeve 19 and the locking lever 20. The locking lever 20 is provided with a latch 20-3. The torsion return spring 21 biases the locking lever 20 such that when the sliding sleeve 19 aligns with any of the locking recesses 6-13, the latch 20-3 engages into that locking recess 6-13.

An actuation tab 20-2 is provided at the distal region of the locking lever 20. When the actuation tab 20-2 is actuated, the locking lever 20 rotates against the torsion return spring 21, the latch 20-3 disengages from the locking recess 6-13, and the sliding sleeve 19 can move along the slide rail 6-12 to another gear position.

A winding chain joint 19-3 is pivotally connected to the sliding sleeve 19 via a joint axle 19-4. The winding chain joint 19-3 is provided with a third winding chain attachment point 19-1. The second end of the winding chain 14 is connected to the sliding sleeve 19 through the winding chain joint 19-3. An anti-slip stud 19-5 is provided on a right-side surface of the sliding sleeve 19. When a rider presses an inner side of a foot simultaneously against the anti-slip stud 19-5 and the actuation tab 20-2, causing the locking lever 20 to rotate against the torsion return spring 21 and the latch 20-3 to disengage from the locking recess 6-13, the sliding sleeve 19 can be pushed along the slide rail 6-12 to another gear position.

### Embodiment 9

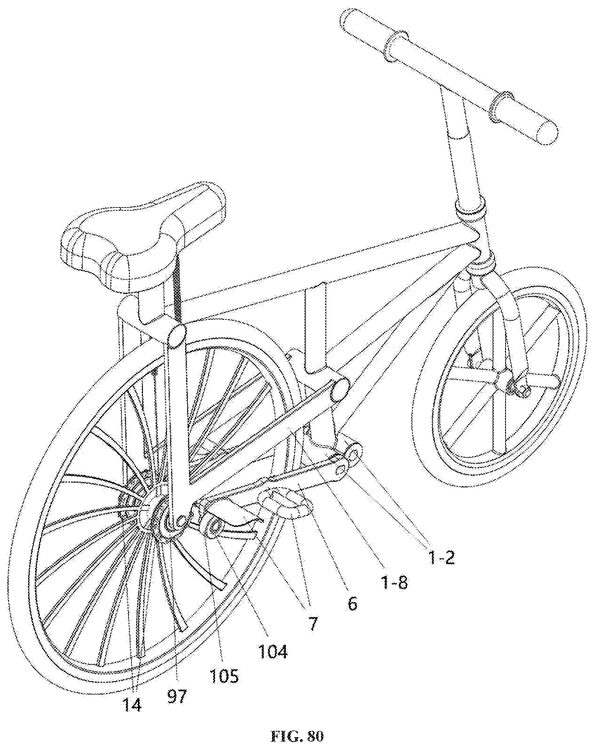

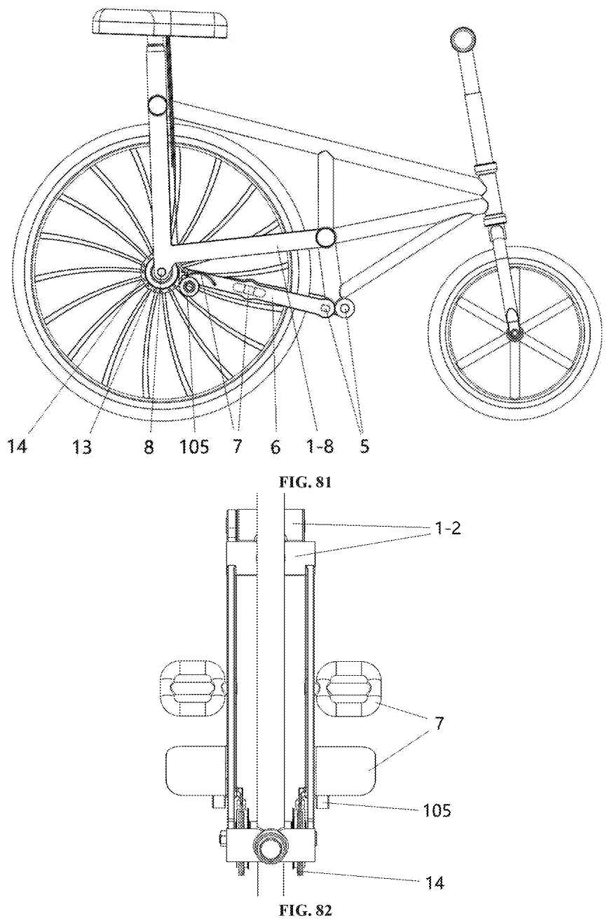

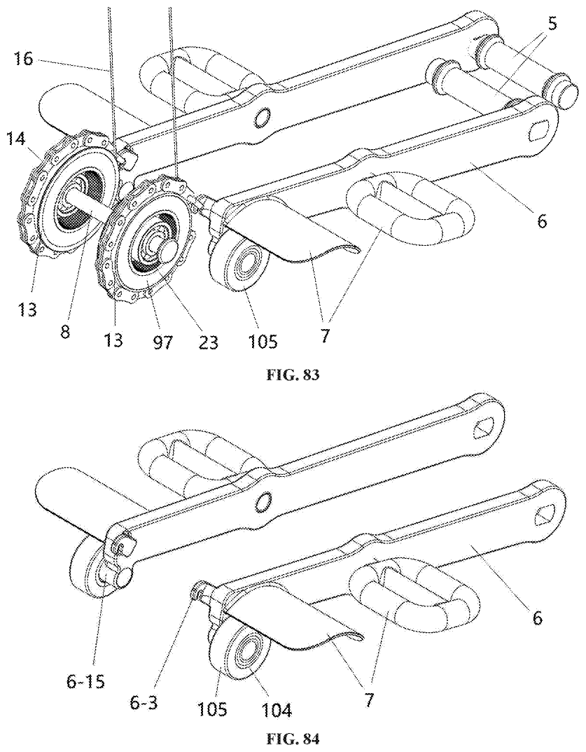

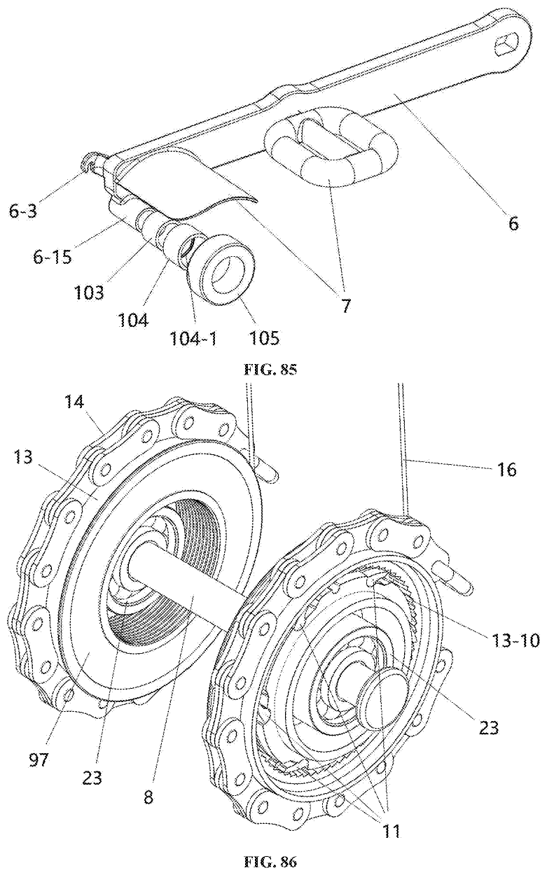

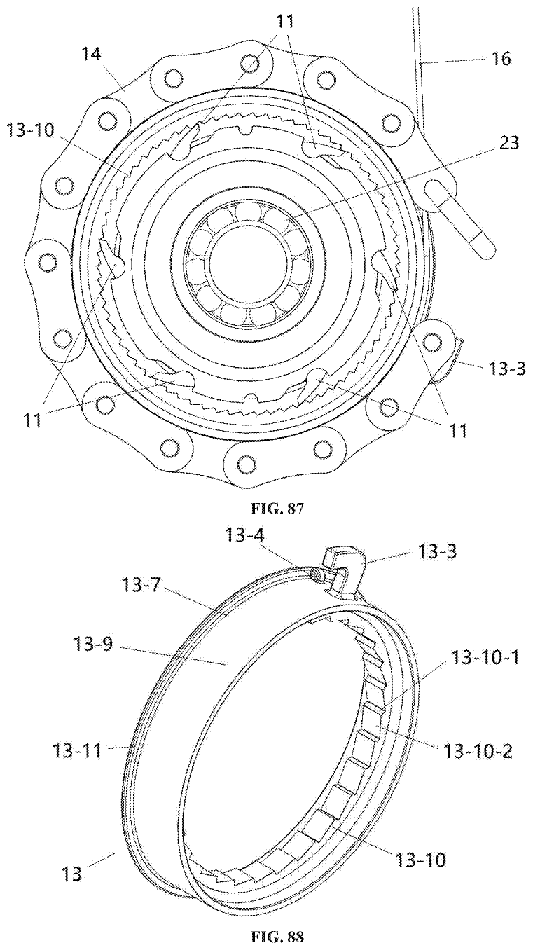

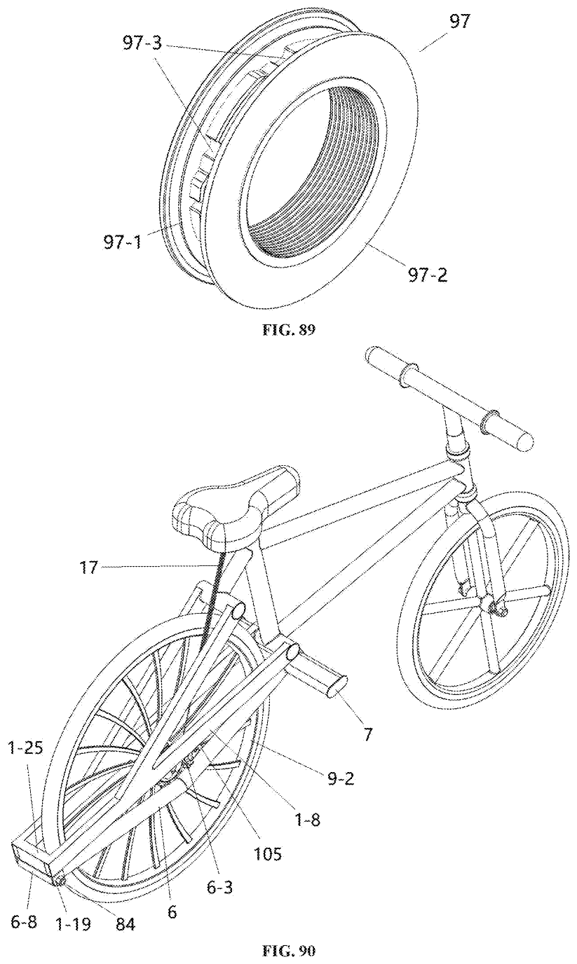

Please refer to FIGS. 80 to 89. Embodiment 9 is similar to Embodiment 7, with the main difference being that Embodiment 9 is provided with two sets of transmission mechanisms disposed on both sides of the drive wheel 9. Two bottom bracket shells 1-2 are arranged side by side in the longitudinal direction of the frame 1 at the middle-lower portion of the frame 1, and a crank axle 5 is pivotally connected in each bottom bracket shell 1-2. An oscillating crank 6 is fixedly connected to the outer end of each of the front and rear crank axles 5 respectively, and the distal region of each oscillating crank 6 faces the rear of the frame 1. When the distal region of the oscillating crank 6 is returned to the return high position under the pulling force transmitted from the spring force of the return mechanism via the winding ring 13 and the winding chain 14, the distal end of the oscillating crank 6 is adjacent to the winding ring 13.

The seat 29 is disposed directly above or rearward of the drive wheel shaft 8, thereby reducing the overall length of the vehicle without affecting its performance.

Two pedals 7 are arranged at the distal end of each oscillating crank 6 along its length direction, the front and rear pedals 7 corresponding to the ball portion and the heel portion respectively.

During the first two-thirds of the pedaling stroke, the rider may mainly depress the rear pedal 7, which corresponds to a longer moment arm, with the heel, thereby obtaining a larger effective moment arm. When the knee joint is about to extend, the ankle joint exerts force to complete the last one-third of the stroke with the ball portion. This significantly reduces the foot lift height in each pedaling stroke, thereby facilitating a higher pedaling rate.

At the same time, this structure provides a long moment arm pedaling mode suitable for uphill riding: on an uphill section, the rider may immediately lift the leg and start the next pedaling stroke when the knee joint is about to extend, depress the rear pedal 7 with the heel throughout the entire stroke, and maintain the effective moment arm near its maximum, thereby generating greater forward driving force.

The pedal 7 corresponding to the ball portion is pivotally connected to the oscillating crank 6, and the pedal 7 corresponding to the heel portion is fixedly connected to the oscillating crank 6.

A second winding chain attachment point 6-3 is provided at the distal end of the oscillating crank 6, and the second end of the winding chain 14 is connected to the second winding chain attachment point 6-3 on the same side.

The effective length of the left oscillating crank 6 is approximately 32 centimeters, and the effective length of the right oscillating crank 6 is approximately 36 centimeters. In one pedaling cycle, the swing angle of the oscillating crank 6 is approximately 42 degrees, and the pedaling stroke of the pedal 7 corresponding to the heel portion is approximately 25 centimeters. During the entire pedaling process, the effective moment arm is relatively close to the maximum value, and the energy utilization efficiency is approximately 97%. The winding chain 14 is a non-endless chain.

In Embodiment 9, three pairs of pawls 11 are mounted on an outer circumferential surface of the winding inner ring 97. The three pairs of pawls 11 are angularly staggered relative to the second ratchet teeth 13-10. Specifically, when distal ends of one pair of pawls 11 abut a front face 13-10-1 of a second ratchet tooth 13-10, distal ends of the other two pairs of pawls 11 press against inclined faces 13-10-2 of the second ratchet teeth 13-10 at different positions. The second ratchet teeth 13-10 formed on an inner circumferential surface of the winding ring 13 have a tooth pitch of approximately 3 millimeters. Consequently, when the distal region of the oscillating crank 6 transitions from automatic upward rebound to downward depression, the winding ring 13 drives the winding inner ring 97 via one pair of pawls 11 within a forward backlash of less than one-third of the tooth pitch (i.e., less than 1 millimeter), thereby significantly reducing the forward backlash of the winding ring 13.

A flexible wire retaining lip 13-11 is provided on an inner portion of the circumferential surface of the winding ring 13. The portion of the circumferential surface adjacent to the flexible wire retaining lip 13-11 defines the flexible wire winding area 13-7, which is provided with a flexible wire attachment point 13-4. The region outward of the flexible wire winding area 13-7 constitutes the winding chain winding area 13-9, which is provided with a first winding chain attachment point 13-3.

A mounting ring 6-15 is provided on the outer side of the distal end of the oscillating crank 6. A foot brake device is mounted on the mounting ring 6-15. The foot brake device includes: a friction inner ring 103 fixedly connected to the mounting ring 6-15; a friction intermediate ring 104 sleeved on the friction inner ring 103; and a rubber outer ring 105 fixedly connected to the outer circumferential surface of the friction intermediate ring 104. The friction intermediate ring 104 is provided with a retaining lip 104-1 to prevent it from moving outward relative to the friction inner ring 103.

When the distal region of the oscillating crank 6 is depressed below the normal pedaling low position, the rubber outer ring 105 contacts and rolls along the road surface, generating sliding friction between the friction intermediate ring 104 and the friction inner ring 103. Since the rider's full body weight is applied to the friction intermediate ring 104 and the rubber outer ring 105 through the distal region of the oscillating crank 6 and the friction inner ring 103, and then directly to the ground through the friction intermediate ring 104 and the rubber outer ring 105, the friction intermediate ring 104 and the rubber outer ring 105 can provide an excellent braking effect and can replace both the front and rear brake systems of a bicycle, despite being extremely small and lightweight.

### Embodiment 10

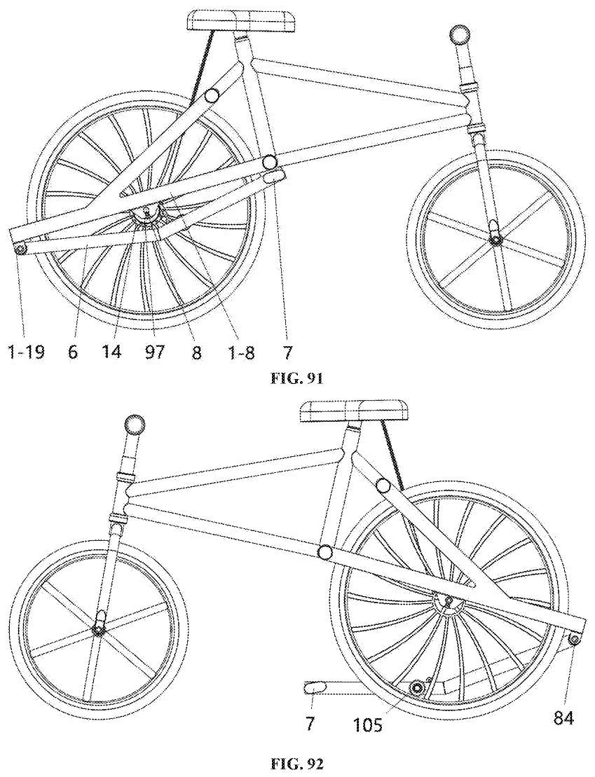

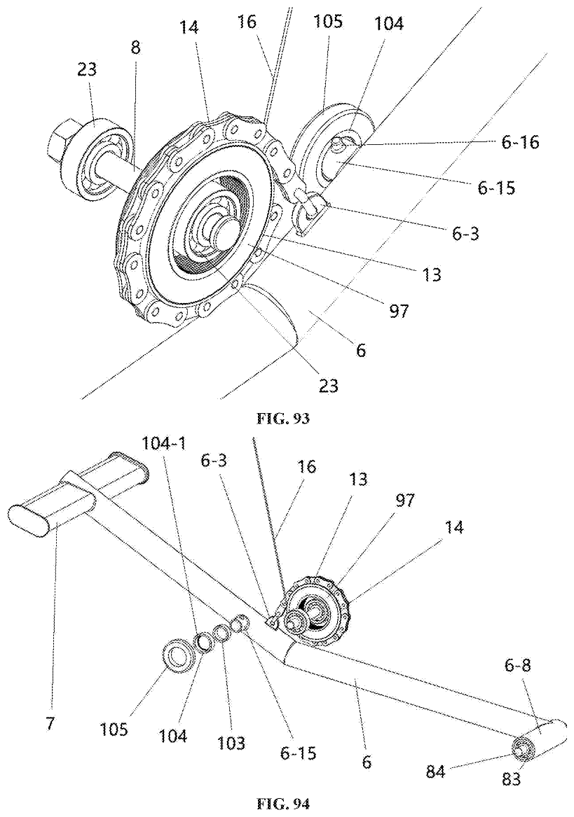

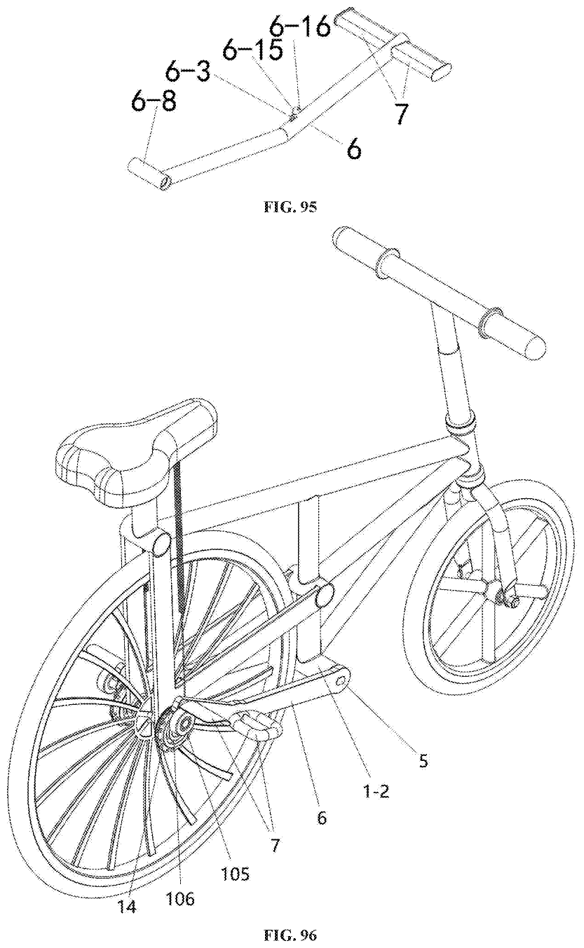

Please refer to FIGS. 90 to 95. Embodiment 10 is generally similar to Embodiment 9, the main difference being that in Embodiment 10, only one set of transmission mechanism is provided, disposed on the right side of the drive wheel 9. In addition, the drive wheel mounting arm 1-8 at the rear end of the frame 1 extends rearward beyond the drive wheel 9, and the rear ends of the drive wheel mounting arms 1-8 are connected by a tail rod 1-25. A pedal base 1-19 is provided at the bottom of the tail rod 1-25.

The pedal device comprises an oscillating crank 6 extending from behind the drive wheel 9 to in front thereof, and a pedal 7 fixedly connected to the front end of the oscillating crank 6. A cross tube 6-8 is provided at the rear end of the oscillating crank 6, a pair of second bearings 83 are mounted at both ends of the cross tube 6-8, and the cross tube 6-8 is pivotally connected to the pedal base 1-19 via the pair of second bearings 83 and a crank axle 84. The second end of the winding chain 14 is connected to a middle or front-middle portion along the length of the oscillating crank 6.

A mounting ring 6-15 is provided on the inner side of the front-middle portion of the oscillating crank 6. A foot brake device is mounted on the mounting ring 6-15. The foot brake device includes: a friction inner ring 103 fixedly connected to the mounting ring 6-15; a friction intermediate ring 104 sleeved on the friction inner ring 103; and a rubber outer ring 105 fixedly connected to the outer circumferential surface of the friction intermediate ring 104.

The friction intermediate ring 104 is provided with a retaining lip 104-1 to prevent it from moving outward relative to the friction inner ring 103. The mounting ring 6-15 is provided with a stop block 6-16 to prevent the friction intermediate ring 104 from moving inward relative to the friction inner ring 103.

The rubber outer ring 105 is laterally aligned with the rim 9-2 of the drive wheel 9. When the distal region of the oscillating crank 6 is depressed below the normal pedaling low position, the rubber outer ring 105 presses against the rim 9-2 of the drive wheel 9. When the rubber outer ring 105 presses against the rotating rim 9-2 of the drive wheel 9, the rubber outer ring 105 rolls along the rim 9-2 of the drive wheel 9, generating sliding friction between the friction intermediate ring 104 and the friction inner ring 103.

### Embodiment 11

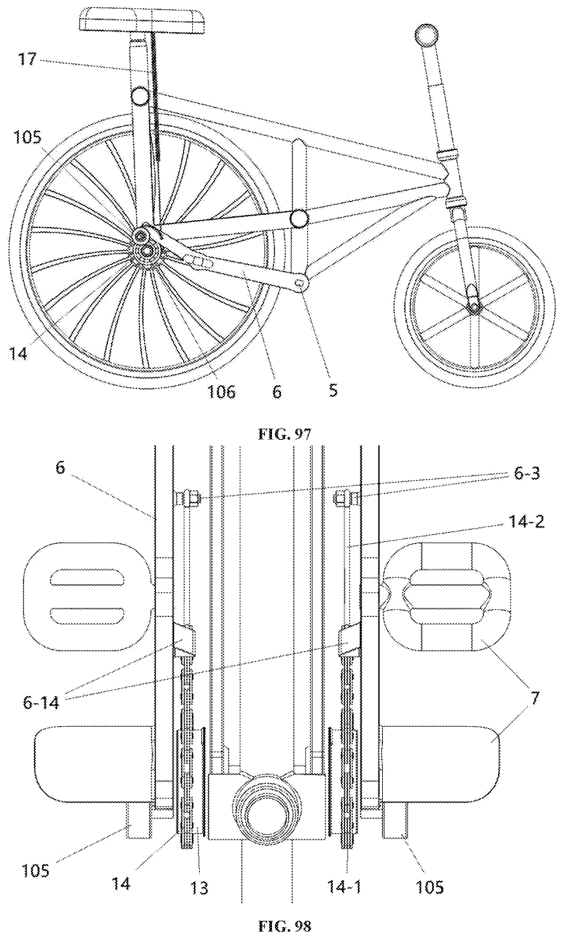

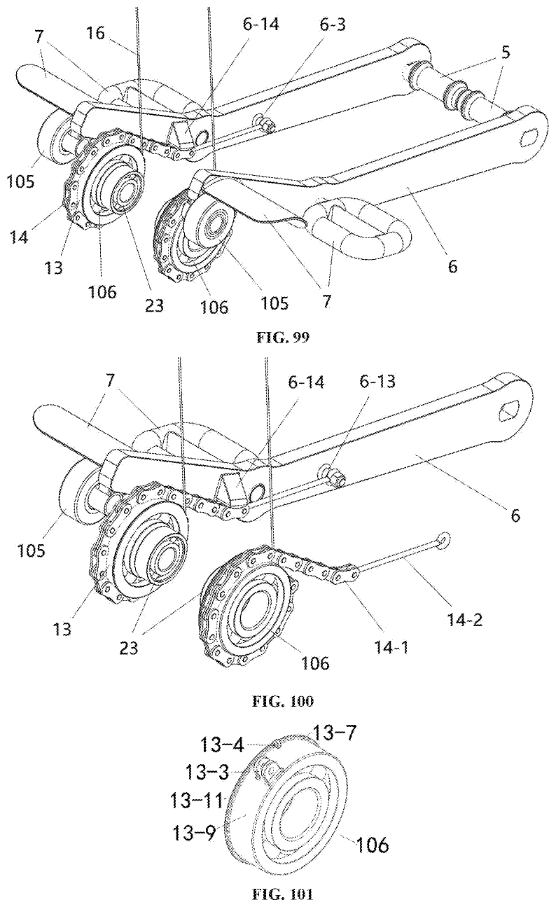

Please refer to FIGS. 96 to 101. Embodiment 11 is generally similar to Embodiment 9, the main difference being that in Embodiment 11, the drive wheel shaft 8 is pivotally connected to the drive wheel mounting arm 1-8 at the rear end of the frame 1 via a pair of first bearings 23, and the drive wheel 9 is fixedly connected to the drive wheel shaft 8. Both ends of the drive wheel shaft 8 extend laterally outward beyond the drive wheel mounting arm 1-8. A one-way bearing 106 is disposed at each end of the drive wheel shaft 8, located outside the drive wheel mounting arm 1-8. The outer races of the left and right one-way bearings 106 serve as the left and right winding rings 13 in this embodiment respectively. Each winding ring 13 is configured to rotate only in a reverse direction relative to an inner race of its corresponding one-way bearing 106. (For convenience of drawing, the structural features of the one-way bearings are not shown.)

A flexible wire retaining lip 13-11 is provided on an inner portion of the circumferential surface of the winding ring 13. The circumferential surface of the winding ring 13 adjacent to the flexible wire retaining lip 13-11 is the flexible wire winding area 13-7, and the flexible wire winding area 13-7 is provided with a flexible wire attachment point 13-4. The region outward of the flexible wire winding area 13-7 constitutes the winding chain winding area 13-9, and the winding chain winding area 13-9 is provided with a first winding chain attachment point 13-3.

The frame 1 is provided with a bottom bracket shell 1-2 having an axis parallel to the transverse direction of the frame 1. Left and right crank axles 5 are pivotally connected side by side within the bottom bracket shell 1-2. An oscillating crank 6 is fixedly connected to an outer end of each of the left and right crank axles 5, and the distal region of each oscillating crank 6 faces the rear of the frame 1. When the distal region of the oscillating crank 6 is returned to the return high position under the pulling force transmitted from the spring force of the return mechanism via the winding ring 13 and the winding chain 14, the distal end of the oscillating crank 6 extends to a position rearward of and above the axis of the drive wheel shaft 8.

A rear portion of the oscillating crank 6, with the front pedal 7 as the reference point, is slightly bent upward so that the distal region of the oscillating crank 6 can be depressed lower. A second winding chain attachment point 6-3 is provided on an inner side surface of the oscillating crank 6 at a middle, front-middle, or rear-middle portion along a length direction thereof. A second end of the winding chain 14 is connected to the second winding chain attachment point 6-3. A protrusion 6-14 is disposed between the second winding chain attachment point 6-3 and the distal end of the oscillating crank 6. The protrusion 6-14 is laterally aligned with the path of the winding chain 14, and a top surface of the protrusion 6-14 is an inclined guide surface.

When the winding chain 14 is positioned above the protrusion 6-14 without contacting the same, the reciprocating-pedaling bicycle is in a low-speed gear. When the winding chain 14 is engaged beneath the protrusion 6-14, the reciprocating-pedaling bicycle is in a high-speed gear.

To shift from the high-speed gear to the low-speed gear, when the distal region of the oscillating crank 6 is at the pedaling low position, a rider uses an inner side of a foot to nudge the winding chain 14 inward, so that the winding chain 14 slides inwardly from under the protrusion 6-14 and is thereby released from the constraint of the protrusion 6-14.

To shift from the low-speed gear to the high-speed gear, when the distal region of the oscillating crank 6 is at the pedaling low position, the rider quickly moves the foot laterally outward away from the pedal 7. The distal region of the oscillating crank 6 then rebounds rapidly upward under the spring force of the return mechanism, exceeding a rebound height during normal pedaling, so that the winding chain 14 slides along the inclined guide surface of the protrusion 6-14 to beneath the protrusion 6-14. Upon a next depression stroke, the winding chain 14 is engaged beneath the protrusion 6-14, thereby automatically completing the shift from the low-speed gear to the high-speed gear.

Thus, the two inherent riding gears provided by the front and rear pedals 7 are further doubled, such that the reciprocating-pedaling bicycle automatically provides four riding gears without requiring a separate gear-shifting mechanism. Combined with a pedaling rate that is more than 80 percent higher than that of a conventional bicycle, no additional gear-shifting mechanism is needed.

The winding chain 14 is composed of a chain portion 14-1 and a rigid steel wire portion 14-2, with a rear end of the chain portion 14-1 connected to a front end of the rigid steel wire portion 14-2.

### Industrial Applicability

The present application belongs to the field of transportation vehicles and is intended for use in transportation. It can serve as a green and environmentally friendly means of transport, potentially replacing existing bicycles and certain types of two-wheeled electric vehicles.

### Additional Remarks

The various technical features described in the above embodiments may be combined in any manner. For the sake of brevity, not every possible combination of the technical features from the aforementioned embodiments has been described. However, any combination thereof that does not involve contradiction shall be considered as falling within the scope of the present description.

The embodiments described above merely represent some implementations of the present application and are described with relative specificity and detail for clarity. Nevertheless, they should not be construed as limiting the scope of the patent claims. It should be noted that, for a person of ordinary skill in the art, several variations and improvements may be made without departing from the inventive concept of the present application, and all such variations and improvements are intended to fall within the protection scope of the present application. Therefore, the protection scope of the present application shall be subject to the appended claims.

What is claimed is:

1. A reciprocating-pedaling bicycle, comprising:
a frame (1);
a head tube (1-1) disposed at a front end of the frame (1);
a front fork (2) pivotally connected in the head tube (1-1);
a front wheel (3) mounted at a lower end of the front fork (2);
a drive wheel (9) and a drive wheel shaft (8) disposed at a rear end of the frame (1);
and a pedal device;
wherein one set or two left and right sets of transmission mechanisms are disposed between the pedal device and the drive wheel (9);
each said transmission mechanism comprising:
a winding ring (13) pivotally connected to the drive wheel (9) or the drive wheel shaft (8), with a one-way transmission mechanism disposed between the winding ring (13) and the drive wheel (9) or the drive wheel shaft (8);
a winding chain (14) having a first end connected to the winding ring (13) and configured to be wound thereon, and a second end connected to the pedal device;
and a return mechanism coupled to the winding ring (13) and configured to rotate the winding ring (13) in the return direction to rewind the winding chain (14) onto the winding ring (13).

2. The reciprocating-pedaling bicycle according to claim 1, wherein:
the return mechanism comprises a flexible wire (16) and a return spring (17);
a first end of the flexible wire (16) is connected to the winding ring (13), and a second end thereof is connected to the return spring (17);
an opposite end of the return spring (17) is connected to the vehicle body;
and the winding ring (13) is provided with a flexible wire winding area (13-7) for winding the flexible wire (16) and a flexible wire attachment point (13-4) for connecting the flexible wire (16).

3. The reciprocating-pedaling bicycle according to claim 1, wherein:
an outer circumferential surface of the winding ring (13) is provided with a winding chain winding area (13-9) for winding the winding chain (14) and a first winding chain attachment point (13-3) for connecting the first end of the winding chain (14).

4. The reciprocating-pedaling bicycle according to claim 1, wherein:
two sets of transmission mechanisms are provided, one on a left side and one on a right side;
the frame (1) is provided with a bottom bracket shell (1-2);
the pedal device includes a left oscillating crank (6) and a right oscillating crank (6), each having a pedal (7) at a distal region thereof;
a second end of each winding chain (14) is connected to the distal region of the oscillating crank (6) on a same side; and
the bottom bracket shell (1-2) and associated crank axles (5) are configured in one of the following two arrangements:
(i) a single bottom bracket shell (1-2) having an axis parallel to a transverse direction of the frame (1), within which left and right crank axles (5) are independently and pivotally connected, the left oscillating crank (6) being fixedly attached to an outer end of the left crank axle (5), and the right oscillating crank (6) being fixedly attached to an outer end of the right crank axle (5); or
(ii) two bottom bracket shells (1-2) arranged side by side along a longitudinal direction of the frame (1), each having an axis parallel to the transverse direction of the frame (1), one crank axle (5) pivotally connected in one of the two bottom bracket shells (1-2) and extending laterally toward the left side of the frame (1), the other crank axle (5) pivotally connected in the other bottom bracket shell (1-2) and extending laterally toward the right side of the frame (1), the left oscillating crank (6) being fixedly attached to a left-extending end of the one crank axle (5), and the right oscillating crank (6) being fixedly attached to a right-extending end of the other crank axle (5).

5. The reciprocating-pedaling bicycle according to claim 1, wherein:
the transmission mechanism comprises a single set disposed on a right side of the drive wheel (9);
the frame (1) is provided with a bottom bracket shell (1-2) having an axis parallel to a transverse direction of the frame (1);
a crank axle (75) is pivotally connected in the bottom bracket shell (1-2);
the pedal device comprises a left oscillating crank (6) and a right oscillating crank (6) fixedly attached to left and right ends of the crank axle (75), respectively, and pedals (7) mounted at distal regions of the respective oscillating cranks (6);
the left and right oscillating cranks (6) are arranged in a mirrored configuration such that, when their distal regions are simultaneously depressed, the driving torques generated on the left and right sides are in the same direction, thereby avoiding mutual cancellation; and
a second end of the winding chain (14) is connected to the distal region of the right oscillating crank (6).

6. The reciprocating-pedaling bicycle according to claim 1, wherein:
two sets of transmission mechanisms are provided, one on a left side and one on a right side;
the pedal device comprises a left reciprocating pedal (70) and a right reciprocating pedal

(70);
each reciprocating pedal (70) is provided with a fourth winding chain attachment point (70-1); and
a second end of each winding chain (14) is connected to the fourth winding chain attachment point (70-1) on a corresponding side.

7. The reciprocating-pedaling bicycle according to claim 6, wherein:
the frame (1) is provided with a pair of guide grooves (1-14), each located forward of a respective end of the drive wheel shaft (8);
each reciprocating pedal (70) is equipped with at least one guide roller (73), the guide roller (73) extending into the corresponding guide groove (1-14); and
side walls of each guide groove (1-14) are configured to guide and constrain the guide roller (73), thereby directing the reciprocating pedal (70) to move along a trajectory defined by the guide groove (1-14).

8. The reciprocating-pedaling bicycle according to claim 4, wherein:
a distal region of each oscillating crank (6) is oriented toward a rear of the frame (1); and
when the distal region is returned to a return high position under a pulling force transmitted from the return mechanism via the winding ring (13) and the winding chain (14), the distal end thereof is positioned adjacent to the winding ring (13) or extends rearward past an axis of the drive wheel shaft (8).

9. The reciprocating-pedaling bicycle according to claim 8, wherein:
two pedals (7) are provided at the distal region of each oscillating crank (6), the two pedals (7) being arranged in a front-rear configuration along a length of the oscillating crank (6) and respectively configured to support the ball portion and the heel portion of a rider's foot.

10. The reciprocating-pedaling bicycle according to claim 8, wherein:
each oscillating crank (6) is provided with a gear-shifting structure comprising:
a second winding chain attachment point (6-3) disposed on an inner side surface of the oscillating crank (6), to which a second end of the winding chain (14) is connected; and
a protrusion (6-14) disposed on the oscillating crank (6) on a side of the second winding chain attachment point (6-3) facing a distal region of the oscillating crank (6), the protrusion (6-14) being laterally aligned with a path of the winding chain (14);
wherein a top surface of the protrusion (6-14) is formed as an inclined guide surface configured to guide the winding chain (14) to slide therealong and become caught beneath the protrusion (6-14) to establish a first connection state;
wherein the winding chain (14) is selectively operable in either the first connection state or a second connection state;
in the first connection state, the winding chain (14) transmits a pulling force to the oscillating crank (6) via the protrusion (6-14); and
in the second connection state, the winding chain (14) is disengaged from the protrusion (6-14) and transmits the pulling force directly through the second winding chain attachment point (6-3).

11. The reciprocating-pedaling bicycle according to claim 8, wherein:
a foot brake device is provided at the distal end of the oscillating crank (6), the foot brake device comprising:
a friction inner ring (103) fixedly secured to the distal end of the oscillating crank (6);
a friction intermediate ring (104) mounted over the friction inner ring (103), the friction intermediate ring (104) being rotatable about the friction inner ring (103) but axially restrained relative thereto; and
a rubber outer ring (105) fixedly attached to an outer circumferential surface of the friction intermediate ring (104).

12. The reciprocating-pedaling bicycle according to claim 11, wherein:
the friction inner ring (103) is fixedly secured to an outer side of the distal end of the oscillating crank (6); and
when a distal region of the oscillating crank (6) is depressed below a normal pedaling low position, the rubber outer ring (105) contacts a ground surface and rolls therealong, thereby generating sliding friction between the friction intermediate ring (104) and the friction inner ring (103) to achieve braking.

13. The reciprocating-pedaling bicycle according to claim 11, wherein:
the friction inner ring (103) is fixedly secured to an inner side of the distal end of the oscillating crank (6);
the rubber outer ring (105) is laterally aligned with a rim (9-2) of the drive wheel (9); and
when the distal region of the oscillating crank (6) is depressed below the normal pedaling low position, the rubber outer ring (105) presses against and rolls along the rotating rim (9-2) of the drive wheel (9), thereby generating sliding friction between the friction intermediate ring (104) and the friction inner ring (103) to achieve braking.

14. The reciprocating-pedaling bicycle according to claim 4, wherein:
each of the left and right oscillating cranks (6) is provided with a respective winding chain connecting arm (6-9); and
a second end of each winding chain (14) is connected to a distal region of the winding chain connecting arm (6-9) on a same side.

15. The reciprocating-pedaling bicycle according to claim 5, wherein:
only the right oscillating crank (6) is provided with a winding chain connecting arm (6-9); and
a second end of the winding chain (14) is connected to a distal region of the winding chain connecting arm (6-9).

16. The reciprocating-pedaling bicycle according to claim 14, wherein:
the winding chain (14) is composed of a chain portion (14-1) and a rigid steel wire portion (14-2) connected in series;
a first end of the chain portion (14-1) is connected to the winding ring (13), a second end thereof is connected to a first end of the rigid steel wire portion (14-2), and a second end of the rigid steel wire portion (14-2) is connected to a distal region of the winding chain connecting arm (6-9).

17. The reciprocating-pedaling bicycle according to claim 4, wherein:
a gear-shifting mechanism is provided at a distal region of the oscillating crank (6), the gear-shifting mechanism comprising:
a slide rail (6-12) provided on the oscillating crank (6);
a sliding sleeve (19) slidably mounted on the slide rail (6-12);
a locking lever (20) configured to lock the sliding sleeve (19) at selected positions along the slide rail (6-12); and
a torsion return spring (21) biasing the locking lever (20) toward a locked position;
wherein the sliding sleeve (19) is provided with a third winding chain attachment point (19-1), and a second end of the winding chain (14) is connected to the third winding chain attachment point (19-1).

18. The reciprocating-pedaling bicycle according to claim 17, wherein:
the locking lever (20) is pivotally connected to the oscillating crank (6);
a distal region of the locking lever (20) is provided with an actuation tab (20-2) and at least one limit stop (20-1);
when two or more limit stops (20-1) are provided, a spacing between adjacent limit stops (20-1) corresponds to a length of the sliding sleeve (19);
the torsion return spring (21) biases the locking lever (20) such that distal ends of the limit stops (20-1) press against the slide rail (6-12), thereby preventing the sliding sleeve (19) from moving along the slide rail (6-12); and
upon operation of the actuation tab (20-2), the locking lever (20) rotates against the bias of the torsion return spring (21), causing distal ends of the limit stops (20-1) to disengage from the slide rail (6-12), thereby allowing the sliding sleeve (19) to move along the slide rail (6-12) to another gear position under a pulling force from the winding chain (14).

19. The reciprocating-pedaling bicycle according to claim 17, wherein:
a plurality of locking recesses (6-13) are provided on the oscillating crank (6) at predetermined intervals;
the locking lever (20) is pivotally connected to the sliding sleeve (19);
a distal region of the locking lever (20) is provided with an actuation tab (20-2), and the locking lever (20) is provided with a latch (20-3);
the torsion return spring (21) is connected between the sliding sleeve (19) and the locking lever (20);
when the latch (20-3), moving with the sliding sleeve (19), aligns with any one of the locking recesses (6-13), the torsion return spring (21) biases the locking lever (20) so as to urge the latch (20-3) into engagement with said locking recess (6-13), thereby locking the sliding sleeve (19) in position; and
upon operation of the actuation tab (20-2), the locking lever (20) rotates against the bias of the torsion return spring (21), disengaging the latch (20-3) from the locking recess (6-13), thereby permitting the sliding sleeve (19) to move along the slide rail (6-12) to another gear position.

20. The reciprocating-pedaling bicycle according to claim 14, wherein:
a gear-shifting mechanism is provided at a distal region of the winding chain connecting arm (6-9), the gear-shifting mechanism comprising:
a slide rail (6-12) provided on the winding chain connecting arm (6-9);
a sliding sleeve (19) slidably mounted on the slide rail (6-12);
a locking lever (20) pivotally connected to the winding chain connecting arm (6-9) via a lever shaft (22);
an actuation tab (20-2) and at least one limit stop (20-1) disposed at a distal region of the locking lever (20);
a torsion return spring (21) connected between the locking lever (20) and the winding chain connecting arm (6-9) and configured to bias the locking lever (20) toward a locked position; and
a third winding chain attachment point (19-1) provided on the sliding sleeve (19), to which a second end of the winding chain (14) is connected;
wherein, when two or more limit stops (20-1) are provided, a spacing between adjacent limit stops (20-1) corresponds to a length of the sliding sleeve (19);
the torsion return spring (21) biases the locking lever (20) such that distal ends of the limit stops (20-1) press against the slide rail (6-12), thereby preventing sliding movement of the sliding sleeve (19); and
upon operation of the actuation tab (20-2), the locking lever (20) rotates against the bias of the torsion return spring (21), causing distal ends of the limit stops (20-1) to disengage from the slide rail (6-12), thereby enabling the sliding sleeve (19) to move along the slide rail (6-12) to another gear position under a pulling force from the winding chain (14).
